(19) United States
(12) Patent Application Publication
(10) Pub. No.: US 2009/0147226 A1
(43) Pub. Date: Jun. 11, 2009

(54) Inner Surface Exposure Apparatus and Inner Surface Exposure Method Technical Field

(76) Inventors: Toshiyuki Horiuchi, Tokyo (JP); Katsuyuki Fujita, Tochigi (JP); Takashi Yasuda, Saitama (JP)

Correspondence Address: WENDEROTH, LIND & PONACK, L.L.P., 1030 15th Street, N.W.,, Suite 400 East, Washington, DC, 20005-1503, US

(21) Appl. No.: 12/087,651

(22) PCT Filed: Dec. 25, 2006
(86) PCT No.: PCT/JP2006/325808

§ 371 Date: Sep. 29, 2008

(30) Foreign Application Priority Data
Jan. 17, 2006 (JP) 2006-034413

(51) Int. Cl. G03B 27/42

(52) U.S. Cl. 355/53

(57) ABSTRACT

An apparatus and a method for exposing a photosensitive material deposited on the inner surface of a tube such as a circular or polygonal tube to light to form a predetermined exposed pattern are provided. The apparatus includes: a guide rod that is inserted into the inner space of an exposure object and emits an exposure light beam toward the inner side of the exposure object; and a stage for changing the relative positions of the exposure object and the guide rod and/or the relative angle between the exposure object and the guide rod. After the irradiation spot of the exposure light beam is brought into focus and/or is adjusted to an exposure starting point, the exposure light beam is projected onto a predetermined position on the exposure object to form a predetermined exposed pattern of a photosensitive material deposited on the inner surface of the exposure object.

### TECHNICAL FIELD

The present invention relates to an exposure-apparatus and an exposure method for exposing an inner surface of an object such as a circular or polygonal tube to form in a predetermined exposed pattern.

### BACKGROUND ART

Lithography is a technique for obtaining a desired fine pattern of a photosensitive material such as a resist. This fine pattern is obtained as follows. The photosensitive material is irradiated with light or a particle beam, such as visible rays, ultraviolet rays, far-ultraviolet rays, vacuum ultraviolet rays, extreme-ultraviolet rays, X-rays, an electron beam, or an ion beam, such that only the desired portion of the photosensitive material is exposed to the light or the particle beam. Thereafter, the photosensitive material is developed to remove the exposed portion when the photosensitive material is a positive photosensitive material or the unexposed portion when the photosensitive material is a negative photosensitive material.

Lithography is widely used for manufacturing semiconductor integrated circuits, optoelectronics devices, liquid crystal panels, micro structures collectively called as micro electromechanical systems (MEMS), sensors, and actuators.

In lithography, various exposure methods are used in the exposure step for exposing the photosensitive material to light to form a desired pattern. These methods are broadly classified into a method in which a mask or reticle is used as an original pattern and a method in which a single or a plurality of light or particle beams are scanned on the exposure object.

The light or particle beams may be scanned on the exposure object in a relative manner. Specifically, the light or particle beams may be moved, the exposure object may be moved, or both the light or particle beams and the exposure object may be moved.

In some cases, the exposure is performed by combining the exposure using a mask or reticle and the exposure using a light or particle beam.

Examples of the exposure using a mask or reticle include: contact exposure in which the exposure is performed with a mask used as an original pattern brought into contact with an exposure object having a photosensitive material applied thereto; proximity exposure in which the exposure is performed with a mask used as an original pattern brought close to an exposure object having a photosensitive material applied thereto; and projection exposure in which the exposure is performed by projecting an original pattern on a reticle onto an exposure object using a projection optical system with a lens or a mirror or using a projection optical system with a combination of lenses and mirrors to thereby form a projection image of the pattern on the reticle.

In the projection exposure, a flat substrate, such as a semiconductor wafer or a glass substrate, which has very high flatness and to which a photosensitive material can be relatively easily applied at a uniform thickness by a method such as spin coating, blade scanning, or spraying is conventionally used as the exposure object.

Recently, methods and apparatuses for performing lithography on the outer surface of an exposure object having a cylindrical shape, a circular tubular shape, or the like have developed.

For example, Patent Document 1 and Non-Patent Document 1 disclose a method and an apparatus for projection exposure. In the method and apparatus, visible light is used as exposure light, and a pattern on a reticle is projected onto the outer surface of a cylindrical exposure object through a projection lens to form a light image of the pattern. In this manner, an exposed pattern of a resist applied to the outer surface of the exposure object is formed.

Non-Patent Document 2 discloses a method and an apparatus for forming a pattern on the surface of a cylinder or a circular tube by exposing the surface to visible light scanned thereon.

In the method and apparatus disclosed in Non-Patent Document 2, the exposing light beam is applied to the cylindrical or circular tubular exposure object, and the exposure object is linearly moved in the axial direction of the cylinder or circular tube and/or is rotated about the axis of the cylinder or circular tube. In this manner, the exposing light beam is scanned relative to the exposure object to perform the exposure.

Non-Patent Document 3 discloses a method for forming a resist pattern on the surface of a cylinder by means of X-ray proximity exposure.

In the exposure method and apparatus disclosed in Non-Patent Document 3, an X-ray mask having a line-and-space pattern is brought close to a cylindrical exposure object, and the exposure is performed in a spiral manner. Specifically, while being rotated about the axis of the cylinder, the exposure object is moved in the axial direction in synchronization with the rotation.

With the above-mentioned methods and apparatuses for performing lithography on the outer surface of an exposure object having a cylindrical shape, a circular tubular shape, or the like, a resist pattern can be formed on the outer surface of the exposure object having a cylindrical shape, a circular tubular shape, or the like. Therefore, the outer surface of the exposure object having a cylindrical shape, a circular tubular shape, or the like can be etched with the resist pattern used as a masking material or can be plated with the resist pattern used as a mold.

However, with the conventional methods, lithography cannot be performed on an inner surface of a structure, such as a circular or polygonal tube, having an enclosed wall.

With the above methods, a screw-like or spline-like component can be produced by forming a resist pattern on the outer surface of an exposure object having a cylindrical or circular tubular shape and then etching the outer surface of the exposure object with the resist pattern used as a masking material or performing plating with the resist pattern used as a female pattern. However, a nut-like or spline-like component engageable with the produced screw-like or spline-like component cannot be produced. Therefore, the produced fine shape of the exposure object having a cylindrical shape, a circular tubular shape, or the like is not fully utilized.

In other words, a method for forming, on an inner surface of an exposure object having a tubular or hole-like inner surface, a fine pattern as fine as the pattern which can be formed on the outer surface of an exposure object having a cylindrical shape, a circular tubular shape, or the like using the lithography described above has not been disclosed.

As a conventional technology for processing an inner surface of an exposure object having a tubular or hole-like inner surface, a method is disclosed in Patent Document 2. Specifically, in this method, as shown in FIG. 29, a laser beam 61 is concentrated by a condensing lens 62, and the direction of the laser beam 61 is changed by a reflecting mirror 63. The laser beam 61 is then projected onto the inner surface of a bearing sleeve 64 having a small diameter circular tubular shape, and the inner surface of the circular tube is selectively melted and evaporated.

With the disclosed method, grooves having a width of 30 to 50 μm can be formed on the inner surface of the bearing sleeve 64.

Patent Document 3 discloses a laser processing method in which a laser spot is formed on the inner surface of a hollow body using a rotatable probe to melt and alloy a metal powder contained in a carrier-protection gas.

However, in the above method in which the inner surface of the exposure object is directly processed through the thermal energy of the laser beam, the material melted and evaporated from the exposure object may be re-deposited on the inner surface of the exposure object. Particularly, when the inner diameter of the exposure object is small, the vapor of the melted and evaporated material is not sufficiently discharged. Therefore, the re-deposition of the melted and evaporated material on non-irradiated lower temperature regions around the melted portion becomes significant. In addition, the processed shape is not smooth, and the processed portion is irregular. Furthermore, the edge of the processed portion may be serrated and may have a raised portion.

Therefore, with the method disclosed in Patent Document 2, which is considered to be more accurate than the method disclosed in Patent Document 3, more accurate and finer processing can be performed as compared to cutting. However, because of the characteristics of bearings, portions other than the processed grooves must be free from any deposits and must be prevented from having any protruding portions. Therefore, although the grooves can be formed, the as processed products cannot be used as final products. Patent Document 2 describes that “a hydrostatic bearing spindle is realized in which its characteristics do not deteriorate even when a bearing gap is about 5 μm.” However, at present, there is a demand for bearings having a smaller bearing gap, and therefore the disclosed technology lacks the required accuracy and fineness.

Moreover, when a high power laser capable of melting a workpiece is used, the beam diameter cannot be greatly reduced. Therefore, highly accurate and finer processing comparable to that obtained by lithography cannot be carried out. In view of the above problems, the present invention has been accomplished as a result of extensive studies.

[Patent Document 1] Publication of Japanese Patent Application No. 2004-171896.

[Patent Document 2] Japanese Patent Application Laid-Open No. Hei 06-315784.

[Patent Document 3] Japanese Patent Application Laid-Open No. Hei 11-320136.

[Non-Patent Document 1] Abstract of the 65th meeting of the Japan Society of Applied Physics, pp. 618, September 2004.

[Non-Patent Document 2] Abstract of the 2002 spring meeting of the Japan Society of Precision Engineering, pp. 564, March 2002.

[Non-Patent Document 3] Digest of Papers, Microprocesses and Nanotechnology 2003, pp. 156-157, October 2003.

### DISCLOSURE OF THE INVENTION

### Problems to be Solved by the Invention

There is provided an apparatus and method for forming a fine pattern of a photosensitive material that has a width of 10 μm or less, which is much finer than a “width of 30 to 50 μm” disclosed in Patent Document 2, on the inner surface of an exposure object having an inner diameter of 1 mm or less, which is much smaller than that of conventional workpieces. With the apparatus and method, processing using a photochemical reaction caused by irradiation with low energy light is realized. In this processing, protrusions of re-deposited materials, unevenness of the processed bottom portions of grooves, and serrated or raised edges of the grooves are not formed which are found in the conventional processing for melting and evaporating a part of the surface through thermal reaction caused by irradiation with a high energy laser beam.

### Means for Solving the Problems

In order to achieve the above object, a first aspect of the invention provides an inner surface exposure apparatus, comprising: exposure light beam supplying means for supplying an exposure light beam, the means including an exposure light source; non-reactive light beam supplying means for supplying a non-reactive light beam for detecting an irradiation spot of the exposure light beam, the means including a non-reactive light source; light guiding means including a guide rod, the guide rod including an optical fiber for guiding the exposure light beam and at least one reflecting element for guiding to an inner surface of an exposure object the non-reactive light beam that enters the exposure object from an incoming side of the exposure light beam or a side opposite to the incoming side and travels in an axial direction of the exposure object; and moving means for moving the exposure object and/or the guide rod such that a relative angle between the guide rod and the exposure object and/or relative positions of the guide rod and the exposure object are changed, wherein, after the irradiation spot of the exposure light beam is focused on a photosensitive material deposited on the inner surface of the exposure object which defines a tubular or hole-like void space and/or is adjusted to an exposure starting point on the photosensitive material, the exposure light beam is projected onto a predetermined position on the exposure object to form a predetermined exposed pattern of the photosensitive material deposited on the inner surface of the exposure object.

The exposure light source 11 is not limited to a light emitting diode. Any light source may be used such as a lamp light source such as a mercury lamp, a xenon lamp, or a halogen lamp or a laser light source such as a blue laser and a violet laser.

In order to expose a predetermined portion of the photosensitive material to the exposure beam to form an exposed pattern having a predetermined shape and a predetermined line width, the focusing and position adjustment of the irradiation spot of the exposure light beam must be performed in advance.

During the focusing and position adjustment, if the exposure light beam is applied to the photosensitive material to an extent greater than the exposure threshold level of the photosensitive material, the photosensitive material is overexposed. Therefore, it is necessary to provide the non-reactive light beam supplying means for emitting the non-reactive light beam to which the photosensitive material is less sensitive.

However, the exposure light source of the exposure light beam supplying means and the non-reactive light source of the non-reactive light beam supplying means are not necessarily provided separately. The exposure light beam and the non-reactive light beam may be separately extracted from the same light source, or each light beam in the required wavelength range may be extracted thorough a filter.

The guide rod is not limited to a circular or polygonal tube and may be a plate or a solid rod. In such a case, the optical fiber is disposed along the outside of the guide rod. Moreover, the guide rod may be formed to have a U-shaped cross-section, and the optical fiber may be placed in the groove. It is important that the exposure light beam be projected perpendicularly onto the photosensitive material.

The optical fiber may have any cross-sectional shape and size and any core diameter. An optical fiber having across-sectional size tapered toward the end portion may be used.

The exposure light beam is scanned on the photosensitive material according to the relative motion between the exposure object and the guide rod. Therefore, the scan is performed by moving and rotating one or both of the exposure object and the guide rod.

If the apparatus is used only for exposure for forming a simple pattern, the exposure object and/or the guide rod is not required to be controlled by a computer and may be moved and rotated using a joystick or a switch.

In a second aspect of the invention, the optical fiber used in the first aspect is not used. In this case, the exposure light beam enters the inner space of the exposure object from a first end side of the guide rod, travels along the guide rod, and is reflected at a right angle from a first reflecting element provided at a second end of the guide rod, whereby the inner surface of the exposure object is exposed to the exposure light beam. In the inner surface exposure apparatus of the second aspect, the non-reactive light beam enters the exposure object from the incoming side of the exposure light beam or the side opposite to the incoming side and travels in the axial direction of the exposure object. The non-reactive light beam is then reflected from a second reflecting element provided in close proximity to the first reflecting element and is projected onto the vicinity of the irradiation position of the exposure light beam on the inner surface of the exposure object.

A light source, such as a laser light source such as a blue laser or a violet laser, that emits a substantially collimated beam is used as the exposure light source.

A shutter may be of any type such as a mechanical open-close shutter, a shutter using an acoustooptical device, or a shutter that controls the ON-OFF condition of a light beam through the inclination angle of a mirror. The installation position of the shutter is not limited to the vicinity of the exposure light source and may be any position so long as the ON and OFF conditions of the exposure light beam can be switched.

A third aspect of the invention provides an inner surface exposure apparatus. In contrast to the apparatus of the second aspect, the inner surface exposure apparatus of the third aspect includes combining means for combining the exposure light beam and the non-reactive light beam, and the guide rod included in the guiding means includes a reflecting element that reflects the combined beam combined by the combining means in a direction orthogonal to the inner surface of the exposure object. The combined beam combined by the combining means enters the inner space of the guide rod, travels in the axial direction of the guide rod, and is reflected in a direction orthogonal to the inner surface of the exposure object by the reflecting element provided in the guide rod. In this manner, the photosensitive material on the inner surface of the exposure object is exposed to the exposure light beam.

The combining means may be a beam splitter, and the beam splitter may be disposed on the guide rod or other supporting body.

A fourth aspect of the invention provides an inner surface exposure apparatus. In contrast to the apparatus of the second aspect, the inner surface exposure apparatus of the fourth aspect includes a guide rod inserted into the inner space of the exposure object from the side opposite to the incoming side of the exposure light beam. The guide rod includes at one end a first reflecting element that reflects the exposure light beam in a direction orthogonal to the inner surface of the exposure object. The exposure light beam is reflected at a right angle from the reflecting element and is projected onto the photosensitive material on the inner surface of the exposure object. The non-reactive light beam enters the exposure object from the incoming side of the exposure light beam or the side opposite to the incoming side and travels in the axial direction of the exposure object. The non-reactive light beam is then reflected from a second reflecting element provided in close proximity to the first reflecting element and is projected onto the vicinity of the irradiation position of the exposure light beam on the inner surface of the exposure object.

Since the optical elements attached to the guide rod are simplified, the guide rod may be a simple rod such as a solid circular or polygonal rod.

A fifth aspect of the invention provides an inner surface exposure apparatus. In contrast to the apparatus of the fourth aspect, the inner surface exposure apparatus of the fifth aspect includes combining means for combining the exposure light beam and the non-reactive light beam, and the guide rod included in the guiding means includes a reflecting element that reflects the combined beam of the exposure light beam and the non-reactive light beam in a direction orthogonal to the inner surface of the exposure object. After being combined by the combining means, the exposure light beam and the non-reactive light beam enters the inner space of the guide rod, travels in the axial direction of the guide rod, is reflected in a direction orthogonal to the inner surface of the exposure object from the reflecting element provided in the guide rod, and is projected onto the inner surface of the exposure object. In this manner, the inner surface of the exposure object is exposed to the exposure light beam.

The combining means may be a beam splitter, and the beam splitter may be disposed on the guide rod or other supporting body. The reflecting element may be a flat mirror or a prism, and a convex lens or a concave mirror may be used in order to narrow the light beam.

A sixth aspect of the invention provides an inner surface exposure apparatus. In contrast to the apparatus of the first aspect, the inner surface exposure apparatus of the sixth aspect includes a light emitting diode serving as the exposure light source, and the light emitting diode is directly attached to the guide rod. In place of the optical fiber, a lead wire for supplying power to the light emitting diode is disposed in the guide rod.

A seventh aspect of the invention provides an inner surface exposure apparatus according to any one of the first to sixth aspects, wherein the exposure object and the guide rod are disposed such that axes thereof are inclined at a predetermined angle. When the axes of the exposure object and the guide rod are along a vertical direction, the flexibility of the arrangement of the components of the inner surface exposure apparatus is increased.

An eighth aspect of the invention provides an inner surface exposure apparatus according to the first or seventh aspect, wherein the optical fiber disposed along the guide rod is bent at one end so as to be perpendicular to the inner surface of the exposure object and wherein the other end of optical fiber is connected to the exposure light source.

A ninth aspect of the invention provides an inner surface exposure apparatus according to the first or seventh aspect, wherein: the optical fiber is disposed along the guide rod; and the guide rod further includes a reflecting element, the reflecting element being provided at a predetermined position in front of an emission end of the optical fiber, the reflecting element reflecting the exposure light beam such that the direction of the exposure light beam is changed to a direction orthogonal to the inner surface of the exposure object.

A tenth aspect of the invention provides an inner surface exposure apparatus according to any one of the fourth, fifth, and seventh aspects, wherein the reflecting element provided at the one end of the guide rod is a reflecting surface formed by mirror-polishing an obliquely cut end of the guide rod.

An eleventh aspect of the invention provides an inner surface exposure apparatus according to any one of the first to tenth aspects, comprising a pinhole part disposed at a position in an optical path of the exposure light beam that extends from the exposure light source to an exposed surface of the exposure object; and an optical system for forming a point image of an emission outlet of the pinhole part on the exposed surface of the exposure object or the vicinity thereof.

A twelfth aspect of the invention provides an inner surface exposure apparatus according to any one of the first to tenth aspects, further comprising one of a pinhole part and a lens for reducing the size of the irradiation spot of the exposure light beam to be projected, the one of the pinhole part and the lens being disposed in the inner space of the exposure object and being placed in an end portion of the guide rod so as to come close to an irradiated portion of the inner surface of the exposure object, the irradiated portion being irradiated with the exposure light beam projected onto the exposure object.

A thirteenth aspect of the invention provides an inner surface exposure apparatus according the first or seventh aspect, further comprising one of a pinhole part and a lens for reducing the size of the irradiation spot of the exposure light beam to be projected, the one of the pinhole part and the lens being disposed at an emission end of the optical fiber that emits the exposure light beam, the emission end being located in an end portion of the guide rod.

A fourteenth aspect of the invention provides an inner surface exposure apparatus according to any one of the first to fifth and seventh to thirteenth aspects, wherein the exposure light beam is a laser beam.

A fifteenth aspect of the invention provides an inner surface exposure apparatus according to any one of the first to fourteenth aspects, wherein the non-reactive light beam has a wavelength range different from that of the exposure light beam.

A sixteenth aspect of the invention provides an inner surface exposure method, comprising the steps of: positioning a guide rod for projection of an exposure light beam in an inner space of an exposure object having a tubular or hole-like void space; before exposure is started, adjusting focus of an irradiation spot of the exposure light beam and/or detecting an exposure starting point; and starting and stopping the projection of the exposure light beam emitted from an exposure light beam emission outlet of the guide rod onto a photosensitive material deposited on an inner surface of the exposure object, the projection of the exposure light beam being performed while a relative angle between the exposure object and the guide rod and/or relative positions of the exposure object and the guide rod are changed continuously or intermittently, wherein after the irradiation spot of the exposure light beam is focused on the photosensitive material deposited on the inner surface of the exposure object which defines a tubular or hole-like void space and/or is adjusted to the exposure starting point on the photosensitive material, the exposure light beam is projected onto a predetermined position on the photosensitive material to form a predetermined exposed pattern of the photosensitive material.

In order to allow the exposure light beam to be projected onto a predetermined correct position on the photosensitive material, an edge of the inner surface of the exposure object or an alignment mark formed on the inner surface of the exposure object is matched to the center of the irradiation spot of the exposure light beam. Then, the exposure object or the guide rod is moved by a predetermined distance and/or angle so that the center of the irradiation spot of the exposure light beam coincides with the exposure starting point on the photosensitive material.

### EFFECTS OF THE INVENTION

With the present invention, lithography can be performed on the inner surface of a hollow exposure object such as a circular or polygonal tube to form a pattern of a photosensitive material. The photosensitive material can be used as a resist. Therefore, the inner surface of the exposure object can be etched by using the pattern of the resist as a masking material or can be plated by using the pattern of the resist as a mold. In this manner, microcomponents such as nut-shaped components and spline tube-like components can be manufactured. In addition, processing of lubrication grooves, air bearing grooves, and the like of a small diameter bearing boss can be performed with high accuracy.

If wet etching is used for etching of the inner surface of the exposure object having the resist pattern serving as the masking material, the etched grooves can have a semi-circular cross-sectional shape. In this manner, ball nuts and ball spline tubes can be manufactured.

In addition, since the pattern is formed by lithography, the pattern is formed through a photochemical reaction caused by exposure of the photosensitive material such as a resist to light. Therefore, advantageously, the energy imparted during the exposure can be much less than that when the inner surface of an exposure object is melted and evaporated.

In lithography, the pattern is formed through development performed after the exposure. Therefore, an unnecessary photosensitive material is completely removed, and an exposed shape having smooth edge lines can be obtained.

If a photosensitive material is used which does not dissolve or dissolve into a developer suddenly bordering on an exposure threshold, the pattern of the photosensitive material can have vertical side walls or sharp side walls close to the vertical side walls.

Moreover, when etching is performed using as a masking material the pattern of the photosensitive material obtained through exposure and development or plating is performed using as a mold the pattern of the photosensitive material, a non-processed portion is covered with the pattern of the photosensitive material. Therefore, advantageously, the base material of the exposure object is free from unnecessary deposits, and the processed shape has no protruding edges.

### BRIEF DESCRIPTION OF THE DRAWINGS

FIG. 1 shows an inner surface exposure apparatus according to a first embodiment (embodiment 1-1) of the present invention.

FIG. 2 shows an inner surface exposure apparatus according to modified embodiment 1-2 of the first embodiment (embodiment 1-1) of the present invention.

FIG. 3 shows an inner surface exposure apparatus according to modified embodiment 1-3 of the first embodiment (embodiment 1-1) of the present invention.

FIG. 4 shows an inner surface exposure apparatus according to modified embodiment 1-4 of the first embodiment (embodiment 1-2) of the present invention.

FIG. 5 shows an inner surface exposure apparatus according to modified embodiment 1-5 of the first embodiment (embodiment 1-4) of the present invention.

FIG. 6 shows an inner surface exposure apparatus according to modified embodiment 1-6 of the first embodiment (embodiment 1-5) of the present invention.

FIG. 7 shows an inner surface exposure apparatus according to modified embodiment 1-7 of the first embodiment (embodiment 1-1) of the present invention.

FIG. 8 shows an inner surface exposure apparatus according to a second embodiment (embodiment 2-1) of the present invention.

FIG. 9 shows an inner surface exposure apparatus according to modified embodiment 2-2 of the second embodiment (embodiment 2-1) of the present invention.

FIG. 10 shows an inner surface exposure apparatus according to modified embodiment 2-3 of the second embodiment (embodiment 2-2) of the present invention.

FIG. 11 shows an inner surface exposure apparatus according to modified embodiment 2-4 of the second embodiment (embodiment 2-3) of the present invention.

FIG. 12 shows an inner surface exposure apparatus according to modified embodiment 2-5 of the second embodiment (embodiment 2-3) of the present invention.

FIG. 13 shows an inner surface exposure apparatus according to modified embodiment 2-6 of the second embodiment (embodiment 2-3) of the present invention.

FIG. 14 shows an inner surface exposure apparatus according to a third embodiment (embodiment 3-1) of the present invention.

FIG. 15 shows an inner surface exposure apparatus according to modified embodiment 3-2 of the third embodiment (embodiment 3-1) of the present invention.

FIG. 16 shows an inner surface exposure apparatus according to modified embodiment 3-3 of the third embodiment (embodiment 3-2) of the present invention.

FIG. 17 shows an inner surface exposure apparatus according to modified embodiment 3-4 of the third embodiment (embodiment 3-2) of the present invention.

FIG. 18 shows an inner surface exposure apparatus according to modified embodiment 3-5 of the third embodiment (embodiment 3-4) of the present invention.

FIG. 19 shows an inner surface exposure apparatus according to modified embodiment 3-6 of the third embodiment (embodiment 3-3) of the present invention.

FIG. 20 shows an inner surface exposure apparatus according to a fourth embodiment (embodiment 4-1) of the present invention.

FIG. 21 shows an inner surface exposure apparatus according to modified embodiment 4-2 of the fourth embodiment (embodiment 4-1) of the present invention.

FIG. 22 shows an inner surface exposure apparatus according to modified embodiment 4-3 of the fourth embodiment (embodiment 4-2) of the present invention.

FIG. 23 shows an inner surface exposure apparatus according to a fifth embodiment of the present invention.

FIG. 24 is a diagram describing the series arrangement of pinholes.

FIG. 25 is a set of diagrams describing the configuration of lenses for forming an image.

FIG. 26 is a set of electron microscope photographs of linear resist patterns in Example 1 of the present invention.

FIG. 27 is a set of electron microscope photographs of a helical resist pattern (a) and a character pattern (b) in Example 2 of the present invention.

FIG. 28 is an electron microscope photograph of a helical fine resist pattern in Example 3 of the present invention.

FIG. 29 is a diagram describing the processing of a groove of a bearing sleeve in a conventional example (described in Patent Document 2).

### DESCRIPTION OF THE REFERENCE NUMERALS

1 exposure object
2 photosensitive material
3 chuck
4a guide rod (on exposure light source side)
4a guide rod (on the side opposite to the exposure light source)
5 exposure light beam
6 optical fiber
7 pinhole part
8a, 8b, 8c lens
9a, 9b, 9c lens holder
10a mirror (flat)
10b mirror (concave)
10c reflecting surface (flat mirror surface)
10d reflecting surface (concave mirror surface)
11 light source (exposure light source such as a light emitting diode)
12 light source (exposure light source, such as a laser, emitting a substantially collimated beam)
13 ferrule
14 rotation stage
Y stage
16 support (for the rotation stage)
17 support
18 X stage
19 ζ stage
20 ξ stage
21 η stage
22 Z stage
23a, 23b base
24 computer
25a, 25b, 25c, 25d, 25e control circuit
30 shutter
31 light emitting diode
32 lead wire
33 circuit (for the light emitting diode)
35 light emitting unit (light emitting diode)
41 support
42 support (for the chuck)
43 supporting member (for the pinhole part)
44 supporting rod
51 non-reactive light source
52 non-reactive light beam
53 beam splitter (for the non-reactive light beam)
54 mirror (for the non-reactive light beam)
55 mirror (for the non-reactive light beam)
56 lens (for the non-reactive light beam)
57 camera
58 monitor
59 beam splitter

### BEST MODES FOR CARRYING OUT THE INVENTION

Hereinbelow, the best modes for carrying out the invention will be described with reference to the drawings.

### First Embodiment

FIG. 1 shows an inner surface exposure apparatus according to a first embodiment (embodiment 1-1) of the present invention. In FIG. 1, reference numeral 1 represents an exposure object having a predetermined shape, such as a circular or polygonal tube shape, having a hollow portion (inner space) therein. A photosensitive material 2 such as a resist or an ultraviolet curable resin is deposited on the inner surface of the exposure object 1 by coating, spraying, electrodeposition, bonding, or other method.

Reference numeral 4a represents a tubular guide rod for guiding an exposure light beam 5 and a non-reactive light beam 52 to the photosensitive material 2 deposited on the inner surface of the exposure object 1. An optical fiber 6 for guiding the exposure light beam 5 is inserted into the inner space of the guide rod 4a. The optical fiber 6 is bent at a substantially right angle at the end portion of the guide rod 4a and passes through a hole in the wall of the guide rod 4a. A lens 8a is attached through a pinhole part 7 and a lens holder 9a to the wall portion of the guide rod 4a through which the optical fiber 6 passes.

The exposure light beam 5 emitted from the emitting end of the optical fiber 6 is focused through the pinhole part 7 and the lens 8a on the photosensitive material 2, whereby an irradiation spot is formed that has a predetermined size and a predetermined shape such as a circular shape, an elliptical shape, a regular polygonal shape, a rectangular shape, or a shape similar thereto.

Reference numerals 54 and 55 represent a pair of mirrors provided on the upper wall of the guide rod 4a. As described later, the pair of mirrors 54 and 55 are provided for guiding the non-reactive light beam 52 to the irradiation spot and its vicinity of the exposure light beam 5 which is formed on the photosensitive material 2.

Reference numeral 11 represents a light emitting diode serving as an exposure light source, and the light emitting diode 11 is connected to one end of the optical fiber 6 through a ferrule 13.

Reference numeral 14 represents a rotation stage that rotates the exposure object 1 held by a chuck 3 about the lengthwise axis (Y axis) of the exposure object 1. For illustrative convenience, the coordinate axes are placed in a position separated from the configuration diagram of the apparatus. However, the origin of the coordinate axes of the exposure object 1 and the guide rod 4a can be arbitrarily chosen, and the Y axis is generally matched to the central axis of the exposure object 1.

Reference numeral 15 represents a Y stage which moves the exposure object 1 in its lengthwise direction (Y direction). Reference numeral 16 represents a support for supporting the rotation stage 14 on the Y stage 15. Reference numeral 18 represents an X stage for moving the exposure object 1 in a direction (X direction) perpendicular to the plane of the paper in FIG. 1. The rotation stage 14, the Y stage 15, and the X stage 18 may be stacked in any order.

Reference numerals 19 to 22 represent moving stages for the guide rod 4a. Reference numeral 19 represents a ζ stage for adjusting the angle around the Z axis, reference numeral 20 represents a ξ stage for adjusting the pitching angle around the X axis, and reference numeral 21 represents an η stage for adjusting the rolling angle around the Y axis. These stages are vertically stacked, and the guide rod 4a and the light emitting diode 11 are secured to the uppermost ζ stage 19.

The ζ stage 19, the ξ stage 20, and the η stage 21 may be stacked in any order, and an inclination adjusting stage that adjusts both the rolling angle around the Y axis and the elevation angle around the X axis may be provided in place of the ξ stage 20 and the η stage 21.

Reference numeral 22 represents a Z stage for adjusting the Z axis position of the guide rod 4a, and reference numeral 23a is a base on which the X stage 18 and the Z stage 22 are placed.

The rotation of the guide rod 4a about the Y axis by the η stage 21 and the rotation of the exposure object 1 about the Y axis by the rotation stage 14 may be the same in a relative sense. The η stage 21 is provided for rotating the guide rod 4a about the Y axis to adjust the emission direction of the exposure light beam 5. Therefore, when the emission direction of the exposure light beam 5 is not required to be changed, the η stage 21 can be omitted.

Reference numeral 24 represents a computer for controlling the rotation stage 14, the Y stage 15, and the X stage 18 for the exposure object 1 and for controlling the ζ stage 19, the ξ stage 20, the η stage 21, and the Z stage 22 for the guide rod 4a.

Reference numerals 25a, 25b, 25c, and 25d represent control circuits including interfaces and provided for operating the above-described stages and the light emitting diode 11 according to a program in the computer 24.

Reference numeral 51 represents a non-reactive light source, reference numeral 53 represents a beam splitter, reference numeral 56 represents a lens, and reference numeral 57 represents a camera. The non-reactive light beam 52 emitted from the non-reactive light source 51 is guided by way of the lens 56, the beam splitter 53, and the pair of mirrors 54 and 55 provided on the guide rod 4a to the irradiation spot and its vicinity of the exposure light beam 5 formed on the photosensitive material 2. The reflection of the non-reactive light beam is received by the camera 57, and an image is formed on a monitor 58.

The image data on the monitor 58 is sent to the computer 24 through the control circuit 25d including the interface, and the computer 24 controls the relative distance and relative inclination angle between the guide rod 4a and the inner surface of the exposure object 1 such that the shape, size, and position of the irradiation spot of the exposure light beam 5 on the photosensitive material 2 are adjusted to predetermined values.

For simplicity, the guide rod 4a and the exposure object 1 may be automatically controlled such that the guide rod 4a is held at a predetermined distance from the photosensitive material 2 on the inner surface of the exposure object 1. It is more preferable that the shape and size of the irradiation spot of the exposure light beam 5 on the inner surface of the exposure object 1 be continuously controlled during exposure.

In order to allow the exposure light beam 5 to be projected onto a predetermined correct position on the photosensitive material 2, first, an edge of the inner surface of the exposure object 1 or an alignment mark formed on the inner surface of the exposure object 1 is matched to the center of the irradiation spot of the exposure light beam 5. Then, the exposure object 1 or the guide rod 4a is moved by a predetermined distance and/or angle so that the center of the irradiation spot of the exposure light beam 5 coincides with an exposure starting point on the photosensitive material 2.

When the non-reactive light beam 52 is not used and the photosensitive material 2 is irradiated with the exposure light beam 5 at an excessively high intensity, the photosensitive material is overexposed. Therefore, the non-reactive light source 51 is used which emits the non-reactive light beam 52 having a wavelength range different from that of the exposure light beam 5, the photosensitive material 2 being less sensitive to the non-reactive light beam 52.

When a light beam in the same wavelength range as that of the exposure light beam 5 or in a wavelength range close to that of the exposure light beam 5 is used as the non-reactive light beam 52, the non-reactive light beam 52 is applied to the photosensitive material 2 only for a short period of time during which the reaction of the photosensitive material 2 does not occur, or the non-reactive light beam 52 is applied at a weak intensity that does not cause the reaction of the photosensitive material 2. The non-reactive light beam 52 may be supplied intermittently for a short time in total.

The exposure light source 11 and the non-reactive light source 51 are not necessarily provided separately. Light beams in the required wavelength ranges may be extracted from a single light source or may be obtained using a filter.

The projected area of the non-reactive light beam 52 on the photosensitive material 2 is adjusted to be greater than the irradiation spot of the exposure light beam 5 so that a wide area around the irradiation spot and its vicinity of the exposure light beam 5 can be observed. The exposure object 1 is not necessarily held at its outer surface on one side by the chuck 3. The exposure object 1 may be held at its outer surface of both sides or at its lower surface.

The exposure light beam 5 emitted from the optical fiber 6 is not necessarily emitted from the end of the guide rod 4a and may be emitted from any portion, such as the central portion, of the guide rod 4a. The emitting direction is not necessarily the upward direction and may be any direction such as the horizontal direction or the downward direction.

In order to guide the exposure light beam 5 to the emission outlet of the guide rod 4a, the optical fiber 6 is inserted into the inner space of the tubular guide rod 4a. In this case, it is important that the emission direction of the exposure beam emitted from the end of the optical fiber 6 be perpendicular to the photosensitive material 2. Generally, the shape of the irradiation spot of the exposure light beam 5 is preferably symmetric in the scanning direction of exposure. When the emission direction of the exposure beam emitted from the end of the optical fiber 6 is adjusted to be perpendicular to the photosensitive material 2, the shape of the irradiation spot of the exposure light beam 5 can be symmetric in the scanning direction of exposure that is performed while the exposure object 1 is rotated about its axis.

The guide rod 4a is not necessarily has a circular or polygonal tube-like shape and may have a solid plate-like or rod-like shape. In such a case, the optical fiber 6 may be placed along the outer surface of the guide rod 4a. Alternatively, the guide rod 4a may be formed to have a U-shaped cross-section, and the optical fiber 6 may be placed in the groove.

The optical fiber 6 may have any cross-sectional shape and size and any core diameter. An optical fiber 6 having a cross-sectional size tapered toward the end portion may be used.

It is needless to say that the exposure light beam 5 should be narrowed so that the photosensitive material 2 is exposed to the exposure light beam 5 to form a fine exposed pattern.

The pinhole part 7 and the lens 8a are disposed in order to shape the exposure light beam 5 into a circular, elliptical, regular polygonal, or rectangular shape or a shape similar thereto and to narrow the exposure light beam 5. The lens 8a is drawn so as to have a spherical shape but can be any convex lens. Of course, the lens 8a is not necessarily a single lens, and a combination of lenses may be used.

The position and number of the pinholes and lenses are not limited to those shown in the figure and can be appropriately changed within the scope not departing from the gist of the invention.

The lens 8a and the lens holder 9a may be integrally formed together, and the emission end of the optical fiber 6 is generally formed into a flat mirror surface. In consideration of the presence or absence of the lens and the characteristics of the lens, it is preferable to form the emission end of the optical fiber 6 into a shape, such as a spherical or quadratic curved surface, that can efficiently focus the exposure light beam 5.

The ferrule 13 attached to the incident end of the optical fiber 6 allows the incident end of the optical fiber 6 to be easily polished to a smooth and flat shape. Furthermore, when the incident end of the optical fiber 6, which has been polished with the ferrule 13 attached thereto, is disposed in close proximity to the light emitting portion of the light emitting diode 11, the collection efficiency of the exposure beam is improved. The light emitting diode 11 and the incident end of the optical fiber 6 polished with the ferrule 13 attached thereto may be disposed so as to be sufficiently spaced apart from each other, and a collection optical system may be disposed therebetween.

The exposure light beam 5 is scanned on the photosensitive material 2 according to the relative motion between the exposure object 1 and the guide rod 4a. Therefore, the scan is performed by moving and rotating one or both of the exposure object 1 and the guide rod 4a.

The above-described stages may be disposed on the stationary side on which the exposure object 1 is secured by the chuck 3 or may be disposed on the guide rod 4a side. All the stages may be collectively disposed on one side, and stages with the same moving direction (axial direction) or the same rotation direction may be disposed on both sides, i.e., the exposure object 1 side and the guide rod 4a side.

Each of the stages may be provided in accordance with need. It is not always necessary to provide all of the rotation stage 14, the Y stage 15, the X stage 18, the ζ stage 19, the ξ stage 20, the η stage 21, and the Z stage 22.

The control circuit 25a for the stages on the exposure object 1 side, the control circuit 25b for the stages on the guide rod 4a side, and the control circuit 25c for the light emitting diode 11 are not necessarily provided separately, and a part or all of the control circuits may be produced integrally.

If the apparatus is used only for exposure for forming a simple pattern, all the stages are not necessarily controlled by the computer 24. Each of the stages may be appropriately controlled using a joystick or a switch, or a part of the stages may be moved manually. Only one of the pinhole part 7 and the lens 8a may be provided. If the exposed pattern is large, pinhole part 7 and the lens 8a may not be disposed.

The exposure light source is not limited to the light emitting diode 11. Any light source may be used such as a lamp light source such as a mercury lamp, a xenon lamp, or a halogen lamp or a laser light source such as a blue laser and a violet laser.

In the present invention, the exposure of the photosensitive material 2 to light causes a photochemical reaction, and the pattern is formed through development performed after the exposure. Therefore, the optical energy imparted during the exposure can be much less than that in ablation processing which is used for, for example, forming grooves in a bearing sleeve by melting and evaporating the material through a thermal reaction, as shown in the conventional example in FIG. 29.

As a specific value, Patent Document 3 describes that “the invention is more preferable when the power of a laser beam is 1.3 to 6 kW.” As can be seen from this description, a laser having an output power of several W to several ten kW must be used as a laser for melt-evaporation processing in the conventional example. However, in the present invention, when a light emitting diode or a laser light source that emits a light beam with high directivity, the light source may be a small power light source with a power of about several 10 mW to about several hundreds mW. A small and low-cost semiconductor laser has a power sufficient for the laser light source, and therefore a small exposure apparatus can be simply produced at low cost.

In this embodiment (embodiment 1-1), lithography can be performed on the inner surface of the circular or polygonal tube-like exposure object having an inner space to form a pattern of the photosensitive material. The photosensitive material can be used as a resist. Therefore, the inner surface of the exposure object can be etched by using the pattern of the resist as a masking material or can be plated by using the pattern of the resist as a mold for plating. In this manner, advantageously, micro components such as nut-shaped components and spline tube-like components can be efficiently and accurately manufactured using a small amount of energy.

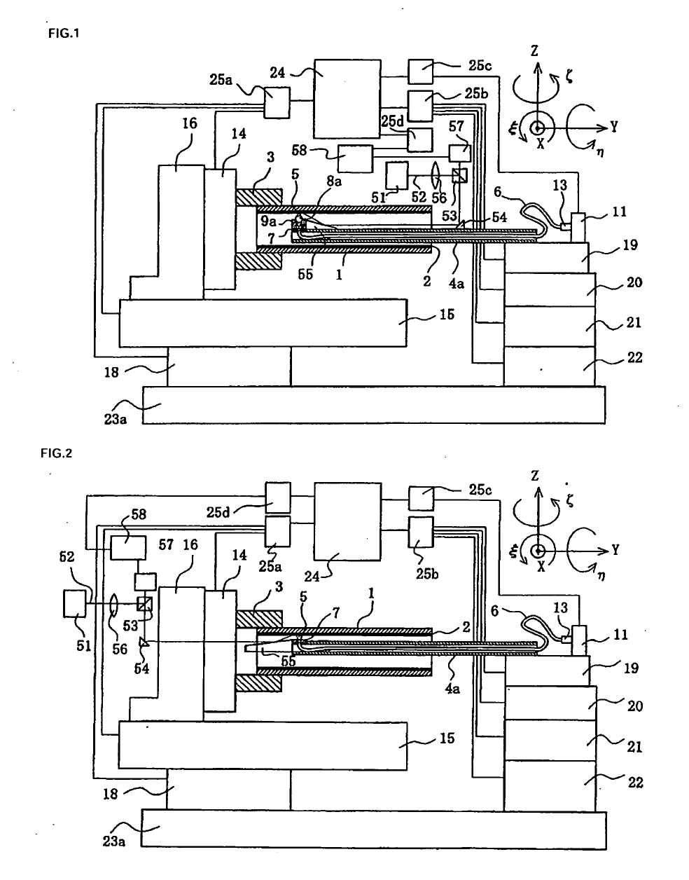

FIG. 2 shows an inner surface exposure apparatus according to modified embodiment 1-2 of the first embodiment. In contrast to the first embodiment (embodiment 1-1) shown in FIG. 1, the lens 8a is omitted, and only the pinhole part 7 is provided. In addition, the non-reactive light source 51 is provided on the side opposite to the exposure light source 11 (on one side of the exposure object 1 held by the chuck 3) relative to the exposure object 1, and the pair of reflecting mirrors 54 and 55 are provided also on the side opposite to the exposure light source 11. The same components as those in embodiment 1-1 are designated by the same reference numerals, and their descriptions are omitted.

Since the lens 8a is omitted and only the pinhole part 7 is provided in contrast to the first embodiment (embodiment 1-1), it is preferable that the emission outlet of the pinhole part 7 be brought as close as possible to the photosensitive material 2 deposited on the inner surface of the exposure object 1, as shown in FIG. 2. The emission outlet of the pinhole part 7 may be softly pressed against the photosensitive material 2. As the emission outlet of the pinhole part 7 comes closer to the photosensitive material 2, the size of the irradiation spot of the exposure light beam 5 projected onto the photosensitive material 2 decreases.

As described above, in contrast to embodiment 1-1, the lens 8a is omitted, and the extent of the pinhole part 7 protruding from the upper surface of the guide rod 4a is suppressed as much as possible. Therefore, advantageously, an exposure object 1, such as a tubular exposure object 1 with a small inner diameter, having a small inner space can be exposed to light.

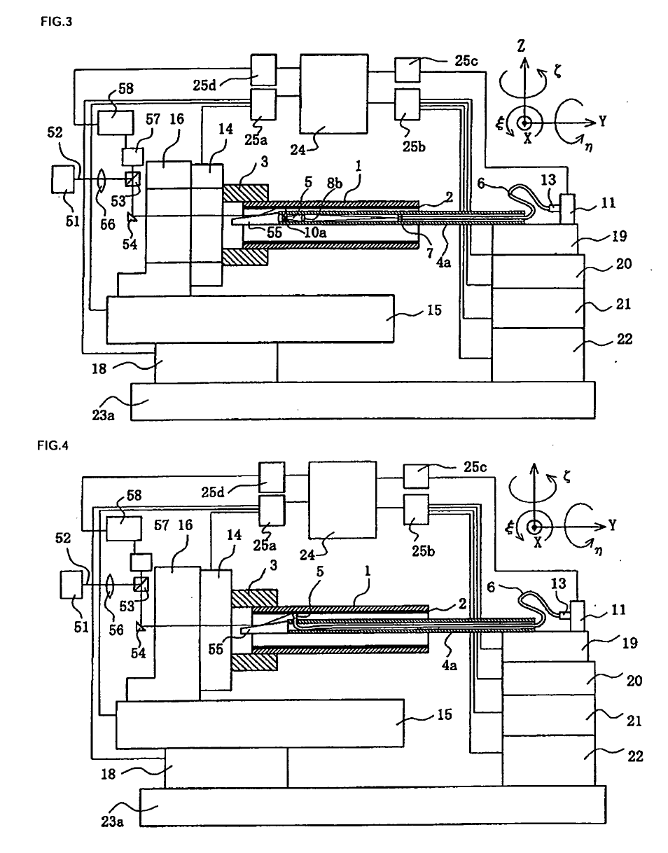

FIG. 3 shows an inner surface exposure apparatus according to modified embodiment 1-3 of the first embodiment (embodiment 1-1). In contrast to embodiment 1-1, the emission end of the optical fiber 6 placed inside the tubular guide rod 4a is disposed at some midpoint of the guide rod. A convex lens 8b for converging the exposure beam is disposed away from the emission end, and a mirror 10a that reflects the exposure light beam 5 at a right angle is disposed further away from the emission end. A light image of the emission outlet of the pinhole part 7 is formed by the lens 8b, and the optical path is bent at a substantially right angle at the mirror 10a. In this manner, the light image is formed on the photosensitive material 2. The same components as those in embodiment 1-1 are designated by the same reference numerals, and their descriptions are omitted.

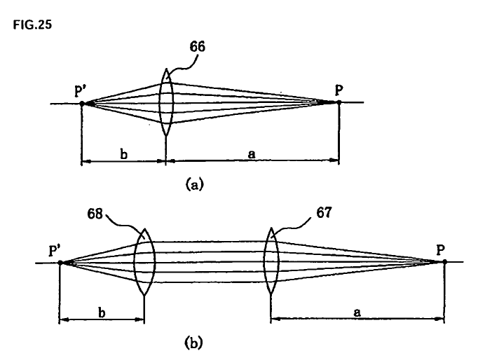

In this embodiment, an imaging optical system is used which forms an image through one lens 66 as shown in FIG. 25(a). In this case, the distance “a” between the lens 8b corresponding to the lens 66 in FIG. 25(a) and the emission outlet of the pinhole part 7 can be much greater than the distance “b” between the lens 8b and the photosensitive material 2 on which the light image is formed. Note that the magnification of the light image is given by m=b/a. Therefore, advantageously, by appropriately selecting the position of the lens 8b, an irradiation spot having a size much smaller than the size of the emission outlet of the pinhole part 7 can be obtained.

Of course, a combination of lenses, in place of the single lens, can be used as the lens 8a in order to improve the image forming ability.

The mirror 10a is not limited to an isosceles triangular mirror and may be any mirror, such as a plate-like mirror, that can reflect the light at a right angle.

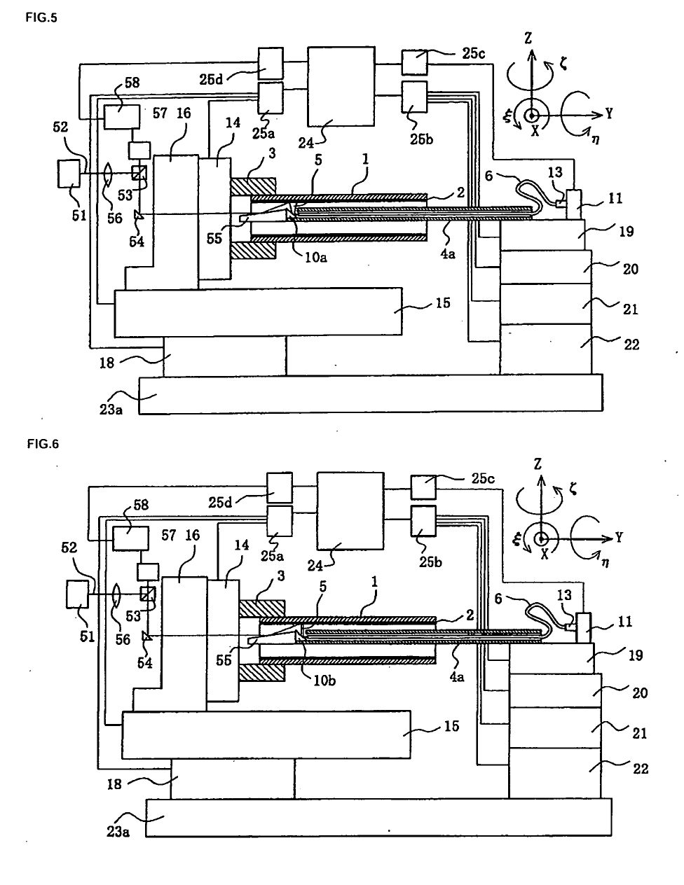

FIG. 4 shows an inner surface exposure apparatus according to modified embodiment 1-4 of the first embodiment (embodiment 1-2). In contrast to embodiment 1-2, the pinhole part 7 is omitted, and the photosensitive material 2 is directly exposed to the light beam emitted from the optical fiber 6 and used as the exposure light beam 5. The same components as those in embodiment 1-2 are designated by the same reference numerals, and their descriptions are omitted.

In this embodiment, the lens 8b and the pinhole part 7 are not provided, and the number of the optical components attached to the guide rod 4a is reduced. Therefore, an exposure object 1 having a smaller inner space can be exposed to light. If an optical fiber 6 having a smaller core diameter and a smaller numerical aperture is used, the exposure light beam 5 can be projected onto a narrower area. In this case, advantageously, the photosensitive material 2 can be exposed to the beam to form a fine exposed pattern.

FIG. 5 shows an inner surface exposure apparatus according to modified embodiment 1-5 of the first embodiment (embodiment 1-4). Instead of bending the disposed optical fiber 6 as in embodiment 1-4, the mirror 10a is provided, and the end of the optical fiber 6 is disposed in close proximity to the mirror 10a. The same components as those in embodiment 1-4 are designated by the same reference numerals, and their descriptions are omitted.

In this embodiment, the end portion of the optical fiber 6 is not required to be bent at a right angle as in embodiment 1-4, and also the end portion of the optical fiber 6 does not pass through the upper wall of the guide rod 4a. Therefore, advantageously, the apparatus can be easily manufactured, and the inner surface of an exposure object 1 having a smaller inner space can be exposed to light.

FIG. 6 shows an inner surface exposure apparatus according to modified embodiment 1-6 of the first embodiment (embodiment 1-5). The flat mirror 10a used in embodiment 1-5 is replaced with a concave mirror 10b. In this case, the light beam emitted from the optical fiber 6 is condensed or the light image of the emission outlet of the optical fiber 6 is formed on the photosensitive material 2. The same components as those in embodiment 1-5 are designated by the same reference numerals, and their descriptions are omitted.

In this embodiment, the convex lens 8a and the pinhole part 7 are omitted to simplify the structure, and the exposure beam is narrowed by the concave mirror 10b. Therefore, advantageously, the inner surface of an exposure object 1 having a small inner space can be exposed to a small irradiation spot.

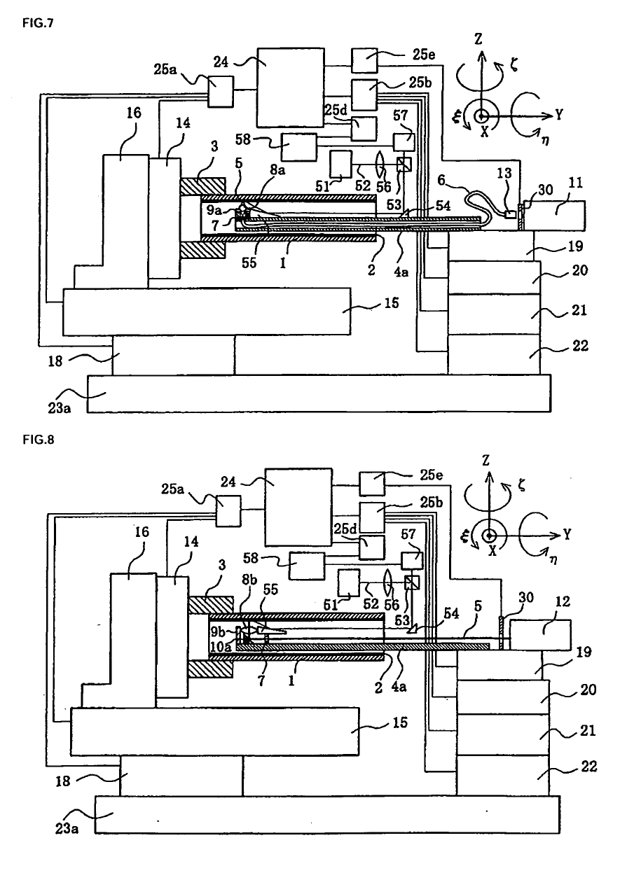

FIG. 7 shows an inner surface exposure apparatus according to modified embodiment 1-7 of the first embodiment (embodiment 1-1). In contrast to embodiment 1-1, a shutter 30 for controlling the ON-OFF condition of the exposure beam is provided between the exposure light source 11 and the ferrule 13 attached to the incident end of the optical fiber 6. The same components as those in embodiment 1-1 are designated by the same reference numerals, and their descriptions are omitted.

The open-close control of the shutter 30 is performed by the computer 24 through the control circuit 25e.

The shutter 30 may be of any type such as a mechanical open-close shutter, a shutter using an acoustooptical device, or a shutter that controls the ON-OFF condition of a light beam through the inclination angle of a mirror. The installation position of the shutter 30 is not limited to the position located immediately in front of the exposure light source 11 and may be any position where the ON and OFF conditions of the exposure light beam 5 can be switched.

Advantageously, in this embodiment, even when a lamp light source or a laser light source, which is not recommended to be frequently turned on and off, is used for the exposure light source, the ON-OFF condition of the exposure light beam 5 is controlled without any limitation.

It is apparent without the need for additional drawings that the mechanism for controlling the ON-OFF condition of the exposure light beam 5 using the shutter 30 as shown in FIG. 7 can be used in modified embodiments of embodiments 1-2 to 1-6 shown in FIGS. 2 to 6.

### Second Embodiment

FIG. 8 shows an inner surface exposure apparatus according to a second embodiment (embodiment 2-1) of the present invention. In contrast to the first embodiment (embodiment 1-7), the optical fiber 6 is omitted, and the exposure light beam 5 emitted from an exposure light source 12 travels along the guide rod 4a, reaches the mirror 10a by way of the pinhole part 7, and forms a predetermined irradiated spot on the photosensitive material 2. The non-reactive light beam 52 is projected by way of the pair of mirrors 54 and 55 mounted on the guide rod 4a onto the irradiation spot and its vicinity of the exposure light beam 5 which is formed on the photosensitive material 2. The same components as those in embodiment 1-7 are designated by the same reference numerals, and their descriptions are omitted.

In this embodiment, a light source, such as a laser, that emits a substantially collimated beam is used as the exposure light source 12. The exposure light beam 5 emitted from the exposure light source 12 is shaped into a circular shape, an elliptical shape, a regular polygonal shape, a rectangular shape, or a shape similar thereto through the pinhole part 7 and is then reflected at a right angle by the mirror 10a. A light image of the pinhole part 7 is formed as an irradiation spot on the photosensitive material 2 by way of the lens 8b supported by a lens holder 9b.

A lamp or light emitting diode may be used as the light source 12, and the divergent beam may be condensed using a mirror or lens to obtain a collimated light beam parallel to the optical axis. Alternatively, two spaced apart pinhole parts 7 may be arranged in series as shown in FIG. 24 to obtain a substantially collimated light beam, and the obtained light beam may be used as the exposure light beam 5. Reference numeral 65 represents a light shielding tube.

A laser beam is a substantially collimated light beam but has an angle of divergence. In addition, the intensity distribution of the laser beam is not always point symmetric. Therefore, when the beam is simply focused using a lens, the size of the irradiation spot of the exposure light beam 5 cannot be greatly reduced, and the irradiation spot cannot be shaped into a desired shape such as a circular shape or a rectangular shape. However, by providing the pinhole part 7, the irradiation spot of the exposure light beam 5 can be further reduced in size and can be shaped into a shape similar to the shape of the emission outlet of the pinhole part 7.

Therefore, in this embodiment, the irradiation spot of the exposure light beam 5 can have a smaller size than that when the laser beam is simply focused using a lens as disclosed in Patent Document 3, and can be shaped into a shape similar to the shape of the emission outlet of the pinhole part 7. Therefore, advantageously, the photosensitive material 2 can be exposed to the beam to form a fine exposed pattern.

FIG. 9 shows an inner surface exposure apparatus according to modified embodiment 2-2 of the second embodiment (embodiment 2-1) of the present invention. In contrast to embodiment 2-1, the exposure light beam 5 and the non-reactive light beam 52 are combined by a beam splitter 59, and the combined light beam travels through the inner space of the guide rod 4a, passes through the pinhole part 7 attached to the guide rod 4a, and is reflected at a right angle by the mirror 10a. The light image of the emission outlet of the pinhole part 7 is formed on the photosensitive material 2 through the lens 8b. The same components as those in embodiment 2-1 are designated by the same reference numerals, and their descriptions are omitted.

In this embodiment, the non-reactive light beam 52 reflected from the photosensitive material 2 returns along the same path as the incoming path of the combined light beam until it reaches the beam splitter 59 on the guide rod 4a and is reflected from the beam splitter 59. The reflected beam is captured by the camera 57 and is observed on the monitor 58. The image data on the monitor 58 is sent to the computer 24 through the control circuit 25d including an interface.

The combined beam includes the non-reactive light beam 52 and the exposure light beam 5, and the shape and size of the irradiation spot of the non-reactive light beam 52 on the photosensitive material 2 are not required to be the same as the shape and size of the exposure light beam 5. The focal length of the lens 56 is selected such that the non-reactive light beam 52 is projected onto the irradiation spot and its vicinity of the exposure light beam 5 and forms an irradiation spot having a sufficient size for observation.

In this embodiment, since the exposure light beam and the non-reactive light beam are combined by the beam splitter 59, the pair of mirrors 54 and 55 and the like for guiding the non-reactive light beam are not required. Therefore, advantageously, the apparatus can be simplified and reduced in size, and the inner surface of an exposure object 1 having a small inner space can be easily exposed to the light beam.

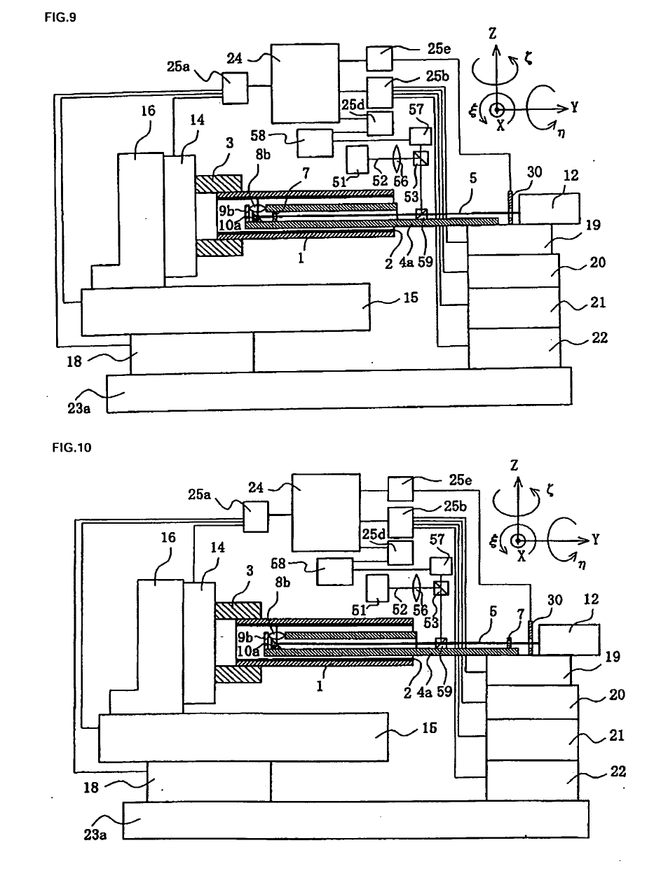

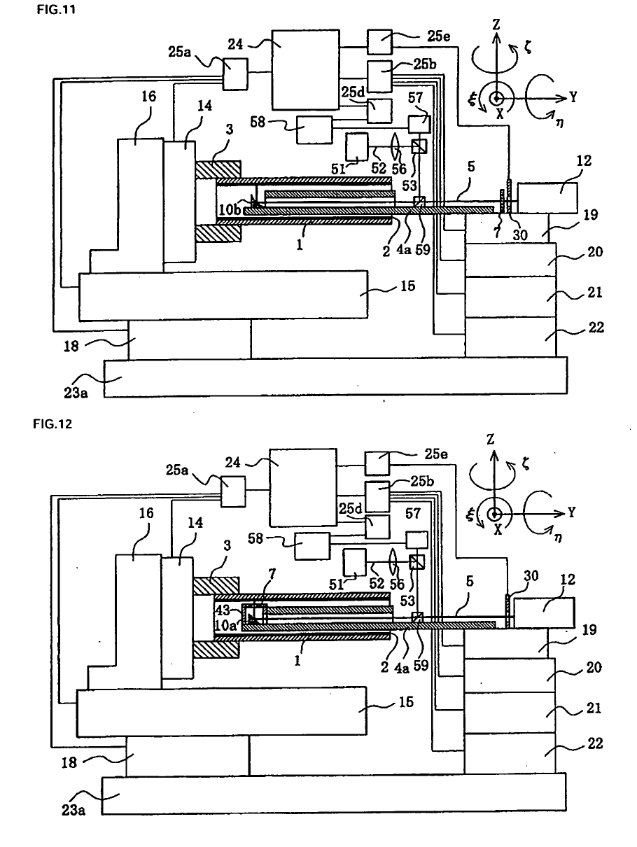

FIG. 10 shows an inner surface exposure apparatus according to modified embodiment 2-3 of the second embodiment (embodiment 2-2) of the present invention. In embodiment 2-2, the pinhole part 7 is disposed at the end of the guide rod 4a. However, in this embodiment, the pinhole part 7 is moved to a position immediately in front of the shutter 30. The same components as those in embodiment 2-2 are designated by the same reference numerals, and their descriptions are omitted.

In this embodiment, the pinhole part 7 is spaced apart from the lens 8b. Therefore, advantageously, the size of the light image of the pinhole formed on the photosensitive material 2, or the irradiation spot of the exposure light beam 5 on the photosensitive material 2, can be reduced independently of the size of the non-reactive light beam 52. Also advantageously, since the pinhole part 7 is disposed outside the supply optical path of the non-reactive light beam 52 and the observation optical path of the reflected beam, a clear and bright irradiation spot of the exposure light beam 5 can be observed.

FIG. 11 shows an inner surface exposure apparatus according to modified embodiment 2-4 of the second embodiment (embodiment 2-3) of the present invention. In this embodiment, the lens 8b and the mirror 10a used in embodiment 2-3 are replaced with the concave mirror 10b. The same components as those in embodiment 2-3 are designated by the same reference numerals, and their descriptions are omitted.

In this embodiment, while the structure is simplified, the same advantage as that in embodiment 2-2 can be obtained.

FIG. 12 shows an inner surface exposure apparatus according to modified embodiment 2-5 of the second embodiment (embodiment 2-3) of the present invention. In contrast to embodiment 2-3, the convex lens 8b is omitted, and the pinhole part 7 is moved to a position located at the end portion of the guide rod 4a and in close proximity to the inner surface of the exposure object 1. The same components as those in embodiment 2-3 are designated by the same reference numerals, and their descriptions are omitted.

Reference numeral 43 represents a supporting member for the pinhole part 7, and the emission outlet of the pinhole part 7 may be softly pressed against the photosensitive material 2.

Advantageously, in this embodiment, the lens 8b is omitted in contrast to embodiment 2-3, and the apparatus is therefore simplified.

FIG. 13 shows an inner surface exposure apparatus according to modified embodiment 2-6 of the second embodiment (embodiment 2-3) of the present invention. In contrast to embodiment 2-3, the lens 8b is moved to a position located in front of the beam splitter 59 and outside the inner space of the exposure object 1. The same components as those in embodiment 2-3 are designated by the same reference numerals, and their descriptions are omitted.

In this embodiment, in contrast to embodiment 2-3, the lens 8b is disposed outside the inner space of the exposure object 1. Therefore, no limitation is imposed on the size of the lens 8b. In addition, the optical components inserted into the inner space of the exposure object 1 can be reduced in size. Therefore, advantageously, the inner surface of an exposure object 1 having a smaller inner space can be exposed to the light beam.

### Third Embodiment

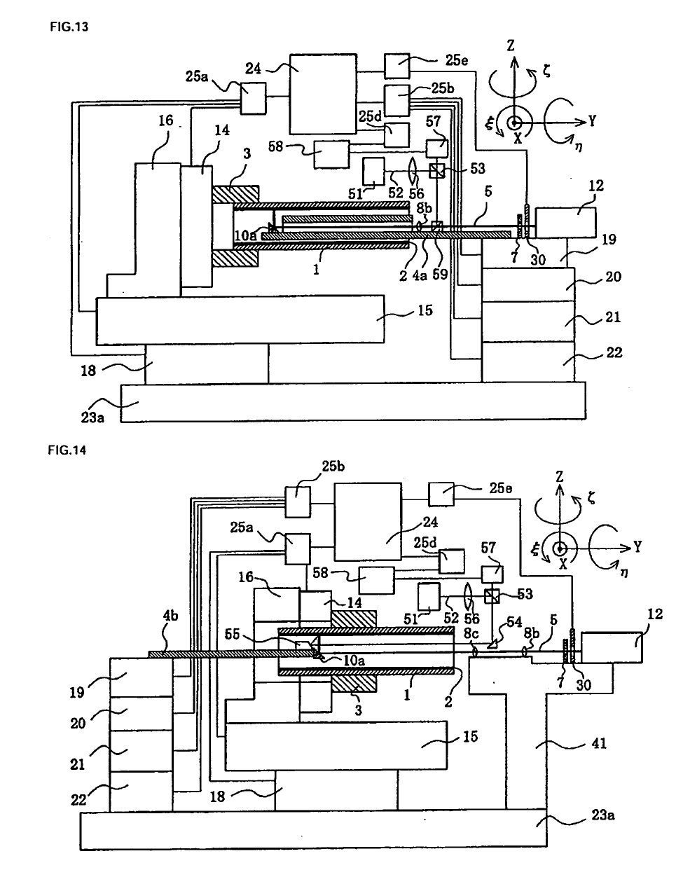

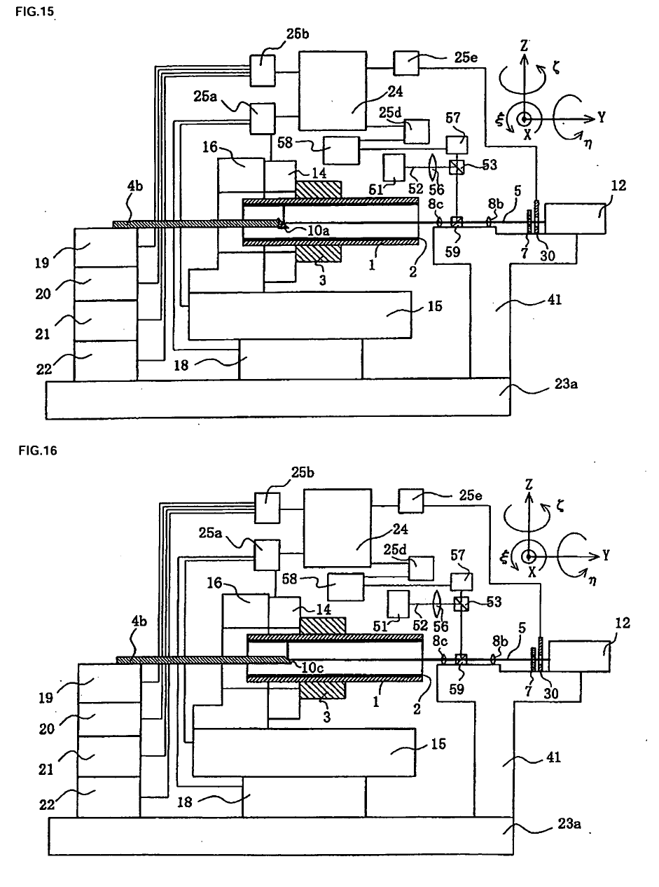

FIG. 14 shows an inner surface exposure apparatus according to a third embodiment (embodiment 3-1) of the present invention.

In FIG. 14, reference numeral 41 represents a support, and the support 41 supports the light source 12, the shutter 30, the pinhole part 7, a pair of lenses 8b and 8c, and optical components (such as the light source 51 and the lens 56) of the optics for the non-reactive light beam. Reference numeral 16 represents a support for supporting the rotation stage 14, and the support 16 is secured to the Y stage 15. The rotation stage 14, the Y stage 15, and the X stage 18 allow the exposure object 1 to be rotated about the Y axis and to be moved in the Y direction and the X direction.

A guide rod 4b has the mirror 10a attached to one end thereof and is inserted into the exposure object 1 from the side opposite to the exposure light source 12. The other end of the guide rod 4b is secured to the uppermost one of the stacked stages including the ζ stage 19, the ξ stage 20, the η stage 21, and the Z stage 22. Each of the support 41, the X stage 18, and the Z stage 22 is secured to the base 23a).

The exposure light beam 5 emitted from the exposure light source 12 reaches the mirror 10a at the end portion of the guide rod 4b through the shutter 30, the pinhole part 7, and the pair of lenses 8b and 8c and is reflected at a right angle by the mirror 10a, and the irradiation spot is formed on the photosensitive material 2. Preferably, the image of the pinhole part 7 is formed on the photosensitive material 2 using an optical system shown in FIG. 25(b) composed of the lenses 8b and 8c. To improve the image forming ability, each of the lenses 8b and 8c may be a combination of lenses. The non-reactive light beam 52 is projected onto the irradiation spot and its vicinity of the exposure light beam 5 on the photosensitive material 2 by way of the mirror 54 secured to the support 41 and the mirror 55 attached to the upper end portion of the guide rod. The same components as those in embodiment 2-1 are designated by the same reference numerals, and their descriptions are omitted.

In this embodiment, only the mirrors 10a and 55 are attached to the guide rod 4b, and therefore the structure of the guide rod 4b is simplified. Advantageously, since the simplified guide rod 4b is inserted into the inner space of the exposure object 1, the inner surface of an exposure object 1 having a small inner space can be exposed to the light beam.

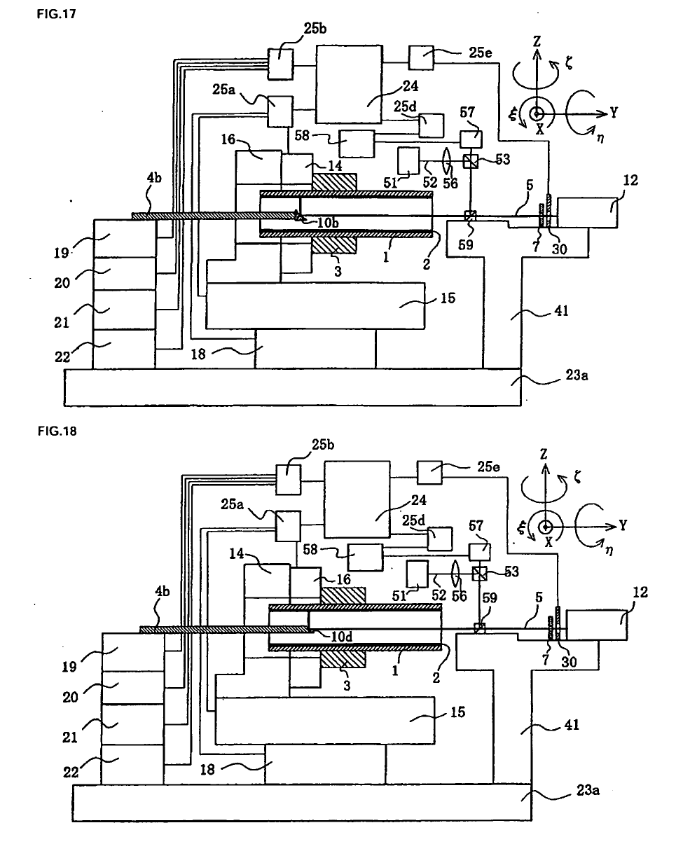

FIG. 15 shows an inner surface exposure apparatus according to modified embodiment 3-2 of the third embodiment (embodiment 3-1) of the present invention.

In contrast to embodiment 3-1, abeam splitter 59 is disposed between the pair of lenses 8b and 8c. After having passed through the shutter 30, the pinhole part 7, and the lens 8b, the exposure light beam 5 emitted from the light source 12 is combined with the non-reactive light beam 52 by the beam splitter 59. The combined light beam passes through the lens 8c and is then reflected at a right angle by the mirror 10a in the end portion of the guide rod 4b as in embodiment 3-1. In this manner, a predetermined irradiation spot is formed on the photosensitive material 2.

When a lens image is formed, a method can be used in which the image is directly formed through the single lens 66 as shown in FIG. 25(a), or a method can be used in which the image is formed through two infinity corrected lenses 67 and 68 as shown in FIG. 25(b). However, in this embodiment, the image is formed through the two lenses. The point P is an object point corresponding to the opening of the pinhole part 7, and the point P′ corresponds to an image point on the photosensitive material 2. The same components as those in embodiment 3-1 are designated by the same reference numerals, and their descriptions are omitted.

In FIGS. 14 and 15 (including FIGS. 16, 17, and 18 described later), the distance between the image point on the photosensitive material 2 and the lenses 8b and 8c must be kept constant. Therefore, during exposure, the scan is performed while the guide rod 4b is held stationary and the exposure object 1 is moved and/or rotated. When the exposure object 1 is a circular tube, it is preferable to allow the exposure light beam 5 to travel along the center axis of the tube. In this case, the scan may be performed while the guide rod 4b is rotated and the exposure object 1 is moved in the Y direction or while the exposure object 1 is held stationary and the guide rod 4b is rotated and moved.

In this embodiment, the lenses 8b and 8c are not disposed in the inner space of the exposure object 1. In addition, in contrast to embodiment 3-1 (FIG. 14), the guide rod 4b to which only the mirror 10a is attached is inserted into the inner space of the exposure object 1. Therefore, advantageously, the inner surface of an exposure object 1 having a smaller inner space can be exposed to the light beam.

FIG. 16 shows an inner surface exposure apparatus according to modified embodiment 3-3 of the third embodiment (embodiment 3-2) of the present invention. In this embodiment, the mirror 10a separately attached to the guide rod 4b in embodiment 3-2 is replaced with a reflecting surface 10c that is formed by mirror-polishing an obliquely cut end of the guide rod 4b. The same components as those in embodiment 3-2 are designated by the same reference numerals, and their descriptions are omitted.

By adding a film of high reflectivity metal such as silver or aluminum or a multilayer film of a high reflectivity dielectric material corresponding to the wavelength of the exposure light beam to the mirror surface at the end of the narrow guide rod 4b, the reflectivity can be further increased.

In this embodiment, the mirror 10a provided separately in embodiment 3-2 is omitted. Therefore, advantageously, the cost of the apparatus can be reduced. In addition, only the guide rod 4b having a simple structure is inserted into the inner space of the exposure object 1. Therefore, advantageously, the inner surface of an exposure object 1 having a very small inner space can be exposed to the light beam.

FIG. 17 shows an inner surface exposure apparatus according to modified embodiment 3-4 of the third embodiment (embodiment 3-2) of the present invention. In this embodiment, the concave mirror 10b is used in place of the flat mirror 10a at the end of the guide rod 4b that is used in embodiment 3-2. The same components as those in embodiment 3-2 are designated by the same reference numerals, and their descriptions are omitted.

In this embodiment, the lenses 8b and 8c used in embodiment 3-2 are omitted, and therefore the cost of the apparatus can be reduced. In addition, only the guide rod 4b having the concave mirror 10b attached thereto is inserted into the inner space of the exposure object 1. Therefore, advantageously, the inner surface of an exposure object 1 having a small inner space can be exposed to the light beam as in embodiment 3-2.

FIG. 18 shows an inner surface exposure apparatus according to modified embodiment 3-5 of the third embodiment (embodiment 3-4) of the present invention. In embodiment 3-4, the mirror 10b is separately attached to the guide rod 4b. However, in this embodiment, the mirror 10b is replaced with a reflecting surface 10d formed by mirror-polishing an end portion of the guide rod 4b into a concave shape. The same components as those in embodiment 3-4 are designated by the same reference numerals, and their descriptions are omitted.

In this embodiment, the concave mirror 10b separately attached to the end portion of the guide rod 4b and used in embodiment 3-4 is omitted, and therefore the cost of the apparatus can be reduced. In addition, only the narrow guide rod 4b is inserted into the inner space of the exposure object 1. Therefore, advantageously, the inner surface of an exposure object 1 having a very small inner space can be exposed to the light beam.

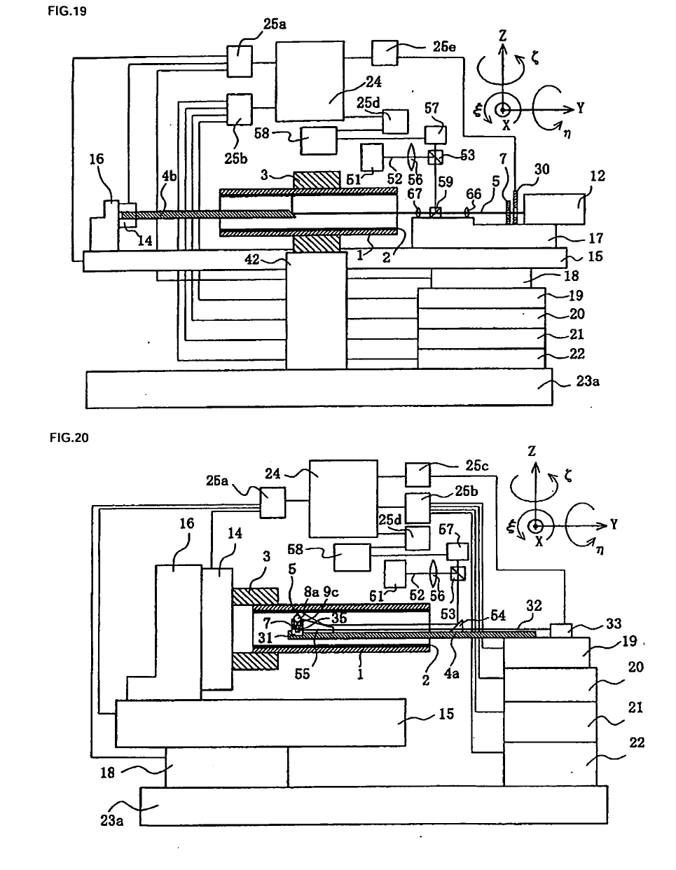

FIG. 19 shows an inner surface exposure apparatus according to modified embodiment 3-6 of the third embodiment (embodiment 3-3) of the present invention.

In embodiment 3-3 (FIG. 16), the exposure object 1 is moved and rotated by the rotation stage 14, the Y stage 15, and the X stage 18. However, in this embodiment, the exposure object 1 is held by the chuck 3 and secured to a support 42.

In addition, the guide rod 4b is rotatably attached to the rotation stage 14 that is placed on the Y stage 15 through the support 16.

The light source 12 emitting the exposure light beam 5, the shutter 30, the pinhole part 7, the light source 51 for the non-reactive light beam 52, the lens 56, the beam splitter 59, the camera 57, and the like are attached to a support 17. The support 17 is secured to the Y stage 15 to which the rotation stage 14 is secured.

The Y stage 15 is placed on top of the successively stacked stages, i.e., the X stage 18, the ζ stage 19, the ξ stage 20, the η stage 21, and the Z stage 22. Therefore, when the light source 12 and other components on the support 17 are moved, the guide rod 4b is also moved together therewith. The same components as those in embodiment 3-3 are designated by the same reference numerals, and their descriptions are omitted.

In this embodiment, all the moving and rotation stages are disposed on the guide rod side. Therefore, advantageously, fine adjustments of the apparatus during the initial stage of the exposure operation (for example, focusing of the exposure light beam 5 on the photosensitive material 2) can be easily made.

It is apparent without the need for additional drawings that, in third embodiments 3-2 to 3-6 (FIGS. 15 to 19) as in embodiment 3-1 (FIG. 14), the reflecting elements 54 and 55 may be provided to guide the non-reactive light beam 52 through an optical path different from the optical path for the exposure light beam 5.

FIG. 20 shows an inner surface exposure apparatus according to a fourth embodiment (embodiment 4-1) of the present invention. The same components as those in the first embodiment (embodiment 1-1) are designated by the same reference numerals, and their descriptions are omitted. This embodiment is different from the first embodiment (embodiment 1-1) in that a light emitting diode 31 is attached to an end portion of the guide rod 4a and that a lead wire 32 for supplying power to the light emitting diode is extended along the guide rod 4a to a lighting circuit 33 disposed on the ζ stage 19.

The light emitting diode 31 is connected to the computer 24 through the lighting circuit 33 and its control circuit 25c, and the ON-OFF state of the light emitting diode 31 is controlled by the computer 24. Reference numeral 7 represents a pinhole part, reference numeral 8a represents a lens, and reference numeral 9c represents a lens holder.

The exposure light beam 5 emitted from the light emission unit 35 of the light emitting diode 31 passes through the pinhole part 7 and the lens 8a and forms a predetermined irradiation spot on the photosensitive material 2.

In this embodiment, the optical fiber 6 used in the first embodiment (embodiment 1-1) is not required. Therefore, advantageously, the guide rod 4a can be easily manufactured. In addition, the optical components, such as the lenses 8b and 8c, the beam splitter 59, and the reflecting mirrors 10a and 10b, for guiding the exposure light beam 5 are not required. Therefore, advantageously, the alignment of the guide rod 4a with these optical components is not required.

FIG. 21 shows an inner surface exposure apparatus according to modified embodiment 4-2 of the fourth embodiment (embodiment 4-1) of the present invention. In contrast to the fourth embodiment (embodiment 4-1), the non-reactive light source 51 is disposed on the side opposite to the lighting circuit 33, and the mirror 55 is attached to an end portion of the guide rod 4a which is on the non-reactive light source 51 side with respect to the light emitting diode 31. In addition, the lens 8a Us omitted. The same components as those in the fourth embodiment (embodiment 4-1) are designated by the same reference numerals, and their descriptions are omitted.

Advantageously, in this embodiment as in the fourth embodiment (embodiment 4-1), the optical fiber 6 is not required, and the guide rod 4a can be easily manufactured. Also advantageously, the optical components, such as lenses and mirrors, for the exposure light beam 5 are not required, and therefore the alignment of the guide rod 4a with these optical components is facilitated.

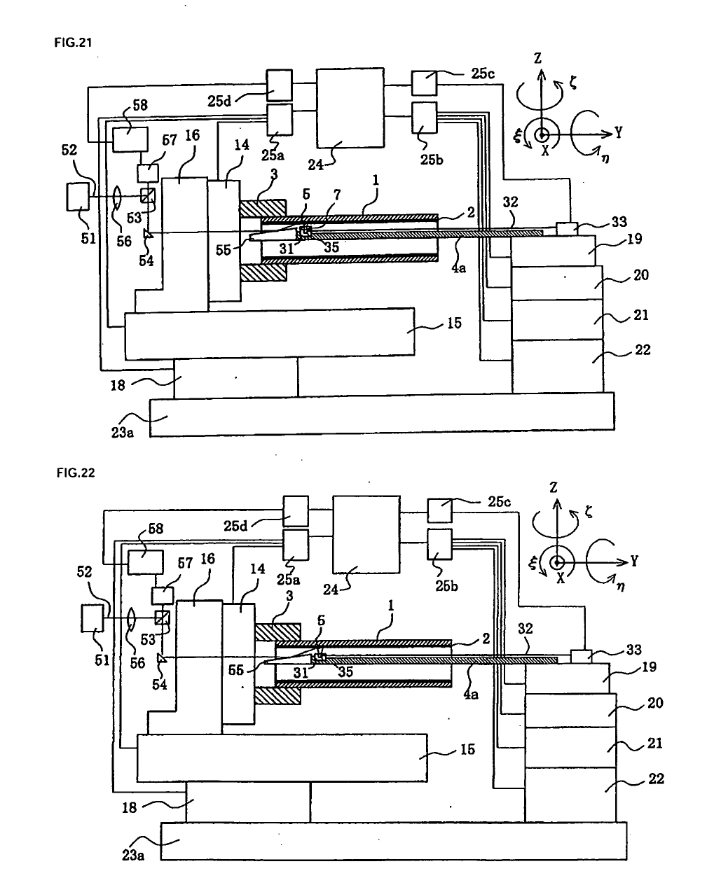

FIG. 22 shows an inner surface exposure apparatus according to modified embodiment 4-3 of the fourth embodiment (embodiment 4-2) of the present invention. In contrast to embodiment 4-2, the pinhole part 7 is omitted. The same components as those in embodiment 4-2 are designated by the same reference numerals, and their descriptions are omitted.

Advantageously, in this embodiment, the guide rod can be more easily manufactured than in embodiment 4-2 (FIG. 21).

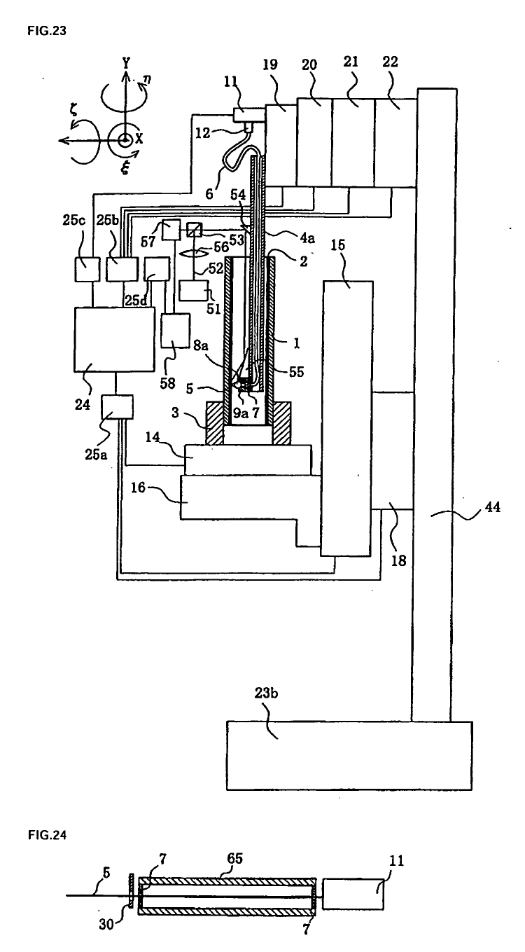

FIG. 23 shows an inner surface exposure apparatus according to a fifth embodiment of the present invention. In contrast to the first embodiment (embodiment 1-1) of the present invention, the exposure object 1 and the guide rod 4a are placed such that their lengthwise direction is along the vertical direction. In addition, a supporting rod 44 is provided in place of the base 23a used in embodiment 1-1 and is mounted on a base 23b. The same components as those in embodiment 1-1 are designated by the same reference numerals, and their descriptions are omitted.

The arrangement of the exposure object 1 and the guide rod 4a is not limited to the arrangement in which the exposure object 1 is on the lower side and the guide rod 4a is on the upper side. The exposure object 1 may be placed on the upper side, and the guide rod 4a may be placed on the lower side. The lengthwise direction of the exposure object 1 and the guide rod 4a is not limited to the vertical direction, and the exposure object 1 and the guide rod 4a may disposed so as to be inclined at a predetermined angle.

The arrangement in which the exposure object 1 and the guide rod 4a are placed such that their lengthwise direction is inclined at a predetermined angle can be used in all the first to fourth embodiments (FIGS. 1 to 22).

Advantageously, in this embodiment, the flexibility of the layout of the apparatus is increased.

Next, a description is given of the inner surface exposure operation of the apparatus according to any one of the first and fourth embodiments (FIGS. 1 to 7 and 20 to 22). In the apparatus, the light emitting diode 11 is used as the exposure light source.

The inner surface exposure apparatus is operated under automatic computer control. The main procedure of the control is as follows.

(1) First, the exposure object 1 is attached to the rotation stage 14 through the chuck 3.

(2) With the light emitting diode 11 turned off, the emission outlet for the exposure light beam 5 that is provided in the guide rod 4a is brought into contact with the inner surface of the exposure object 1 or brought close to the inner surface of the exposure object 1 with a predetermined distance therebetween.

(3) The non-reactive light beam 52 passing through its optical system is projected onto the irradiation spot and its vicinity of the exposure light beam 5 on the photosensitive material 2, and the shape and size of the irradiation spot of the exposure light beam 5 are observed.

(4) The image data on the monitor 58 is sent to the computer 24 through the control circuit 25d including the interface, and the relative distance and relative inclination angle between the inner surface of the exposure object 1 and the guide rod 4a are adjusted. In this manner, the shape and size of the irradiation spot of the exposure light beam 5 that is formed on the inner surface of the exposure object 1 are automatically controlled to predetermined values.

In this case, the automatic control may be performed such that the diameter of the irradiation spot of the exposure light beam 5 on the photosensitive material 2 is minimized. Alternatively, the automatic control may be simply performed such that the guide rod 4a is held so as to be spaced apart from the inner surface of the exposure object 1 by a predetermined distance.

(5) The relative positions and posture angles of the exposure object 1 and the guide rod 4a are adjusted by the rotation stage 14, the Y stage 15, the X stage 18, the ζ stage 19, the ξ stage 20, the η stage 21, and the Z stage 22 according to instructions from the computer.

(6) In order to project the exposure light beam 5 onto the correct exposure starting point on the photosensitive material 2, first, an edge of the inner surface of the exposure object 1 or an alignment mark formed on the inner surface of the exposure object 1 is matched to the center of the irradiation spot of the exposure light beam 5. Then, the exposure object 1 or the guide rod 4a is moved by a predetermined distance and/or angle so that the center of the irradiation spot of the exposure light beam 5 coincides with an exposure starting point on the inner surface of the exposure object 1.

(7) Next, a predetermined stage is moved-rotated, whereby the photosensitive material 2 is exposed to the exposure light beam to form a predetermined exposed shape.

(i) When the exposure object 1 is a circular tube, each of the rotation stage 14 and the Y stage 15 is moved by a predetermined amount while the light emitting diode 11 is tuned ON and OFF. In this manner, the guide rod 4a and the exposure object 1 are moved relative to each other, and the photosensitive material 2 is exposed to the exposure light beam to form a predetermined exposed pattern.

The computer 24 controls at least the rotation of the rotation stage 14 and the movement of the Y stage 15 among the rotation and the movement of the various stages and also controls the ON-OFF state of the light emitting diode 11 and the ON and OFF periods of the light emitting diode 11 or ON-OFF of the exposure according to an exposure position on the exposure object 1. In this manner, the photosensitive material 2 is exposed to the exposure light beam to form a predetermined exposed pattern.

(ii) When the pattern is a spiral shape, a circle on a plane perpendicular to the axis of the circular tube, a shape formed by repeating the formation of the circle, a straight line in the axial direction of the circular tube, or a shape formed by repeating the formation of the straight line, the rotation stage 14 and/or the Y stage 15 is driven at a constant rate, and the light emitting diode 11 is turned on simultaneously with the driven motion, whereby the photosensitive material 2 is exposed to the exposure light beam to form the exposed pattern.

(iii) When the exposure object 1 has a cross sectional shape not symmetric with respect to the center of rotation (hereinafter referred to as a non-symmetric shape), e.g., as a polygonal tube, the distance (in the Z direction) between the photosensitive material 2 and the emission outlet for the exposure light beam 5 that is provided in the guide rod 4a is controlled using the Z stage 22 such that the distance is kept constant. When the non-symmetric exposure object 1 is rotated about the fixed center of rotation while the emission direction of the exposure light beam 5 is unchanged, the direction of the exposure light beam 5 projected onto the photosensitive material 2 is changed, so that the exposure light beam 5 is not always projected perpendicularly onto the exposure surface.

When the non-symmetric exposure object 1 is rotated at a constant rotation rate, the relative moving speed of the guide rod 4a with respect to the photosensitive material 2 varies, and the scan rate of the exposure light beam is not held constant.

Therefore, when the exposure object 1 has a non-symmetric shape, the rotation stage 14 and/or the Y stage 15 and/or the X stage 18 is driven in consideration of the projection angle and scanning speed of the exposure light beam such that the inner surface of the photosensitive material 2 is exposed perpendicularly to the exposure light beam at a constant dose.

For example, when the exposure object 1 is a polygonal tube, the scan and exposure are performed for each plane by moving the exposure object 1 relative to the guide rod 4a using the Y stage 15 and/or the X stage 18.

The scan performed by moving the exposure object 1 and the guide rod 4a relative to each other is not limited to the method in which the motion and irradiation are performed continuously. The predetermined pattern may be obtained as a collection of small exposed areas and/or a collection of exposure points which are formed by the irradiation spot by using a combination of continuous motion and intermittent irradiation and/or a combination of intermittent motion and intermittent irradiation.

(9) When the photosensitive material 2 on the inner surface of the exposure object 1 is exposed to the exposure light beam and the predetermined exposed pattern is formed, the exposure operation is completed. Then, the light emitting diode 11 is turned off at the exposure end point, and each driven stage is stopped.

Next, a description is given of the inner surface exposure operation of the apparatus according to any one of the second and third embodiments (FIGS. 8 to 19) in which a lamp light source or the laser light source 12, which is not recommended to be frequently turned on and off, is used as the exposure light source in place of the light emitting diode 11.

In this inner surface exposure operation, the ON-OFF condition of the exposure light beam is controlled by opening and closing the shutter 30 provided between the light source and the exposure point instead of turning on-off the exposure light source. The rest of the procedure is the same as in the case when the exposure is performed using the inner surface exposure apparatus according to any of the first and fourth embodiments (FIGS. 1 to 7 and 20 to 22).

When the inner surface exposure apparatus according to the fifth embodiment is used in which the inner surface exposure apparatus according to any of the first to fourth embodiments is disposed in an inclined manner, the exposure can be performed as in the case of exposure using the inner surface exposure apparatus according to any of the first to fourth embodiments.

### EXAMPLE 1

Inner surface exposure was performed to form a linear resist pattern under the following conditions using the inner surface exposure apparatus shown in FIG. 2.

### Exposure Object: Aluminum Alloy-Made Circular Tube

Outer diameter: 6 mm, inner diameter: 5 mm, length: 50 mm

### Photosensitive Material on the Inner Surface of the Exposure Object

Resist PMER P-AR900 (product of TOKYO OHKA KOGYO CO., LTD.)

Thickness: about 10 μm

### Exposure Pattern

Linear resist pattern along the lengthwise direction of the inner surface of the circular tube

### Exposure Light Source: Light Emitting Diode (Wavelength: 395 nm)

### Guide Rod: Aluminum Alloy-Made Circular Pipe

Outer diameter: 2.6 mm, inner diameter: 2 mm, length: 58 mm

### Optical Fiber: Plastic Made

Outer diameter 750 μm, core diameter 738 μm

### Pinhole: Nickel Made

Hole diameter: about 170 μm, thickness: 20 μm

### Developer: PMER P-7G

### Relative Speed Between the Exposure Object and the Guide Rod (Exposure Light Beam)

Two speeds: 8 μm/s and 70 μm/s

First, the aluminum-made circular tube used as the exposure object was moved in the Y direction to perform exposure, then immersed in the developer for 4 minutes, and rinsed with pure water for 4 minutes, and the pure water was removed by drying. The aluminum-made circular tube having the pattern formed thereon was cut in the axial direction, and the inner surface was observed under an electron microscope.

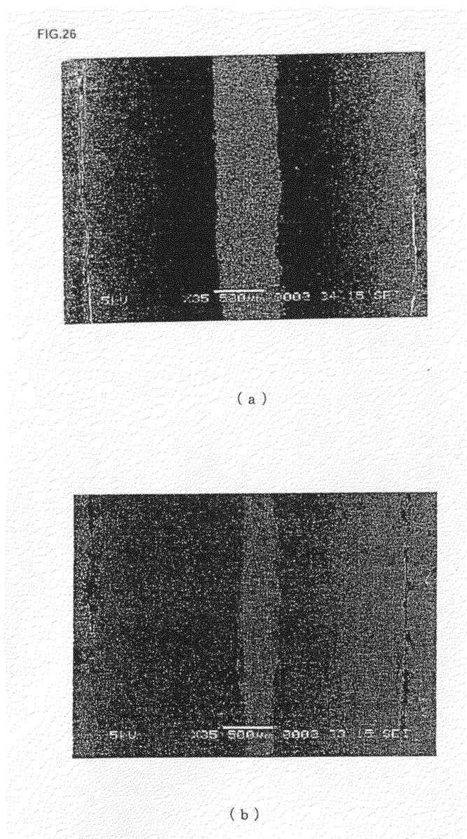

FIG. 26(a) is an electron microscope photograph of the resist pattern when the relative speed between the aluminum-made circular tube and the guide rod was 8 μm/s, and FIG. 26(b) is an electron microscope photograph of the resist pattern when the relative speed between the aluminum-made circular tube and the guide rod was 70 μm/s. The white vertical portion in the central portion of the photograph is the resist pattern, and the black surrounding portion is the resist portion remaining after development. The horizontal scale bar in the lower central portion of the photograph represents a length of 500 μm.

As can be seen, the larger the relative moving speed between the exposure object and the exposure light beam, the narrower the line width of the resist pattern obtained during the development of the resist even when the other developing conditions are the same.

### EXAMPLE 2

Inner surface exposure was performed to form two types of resist patterns (a spiral resist pattern and a character pattern) under the following conditions using the inner surface exposure apparatus shown in FIG. 2.

### Exposure Object: Aluminum Alloy-Made Circular Tube

Outer diameter: 6 mm, inner diameter: 5 mm, length: 50 mm

### Photosensitive Material on the Inner Surface of the Exposure Object

Resist PMER P-AR900 (product of TOKYO OHKA KOGYO CO., LTD.)

Thickness: about 10 μm

### Exposure Pattern

Two types: spiral resist pattern and character resist pattern

### Exposure Light Source: Light Emitting Diode

Wavelength: 395 nm

### Guide Rod: Aluminum Alloy-Made Circular Pipe

Outer diameter: 2.6 mm, inner diameter: 2 mm, length: 58 mm

### Optical Fiber: Plastic Made

Outer diameter 750 μm, core diameter 738 μm

### Pinhole: Nickel Made

Hole diameter: about 100 μm, thickness: 20 μm

### Developer: PMER P-7G

### Relative Speed Between the Exposure Object and the Guide Rod (Exposure Light Beam)

Y direction: 0.5 μm/s

Rotation direction (about the Y axis): about 0.15 deg/s

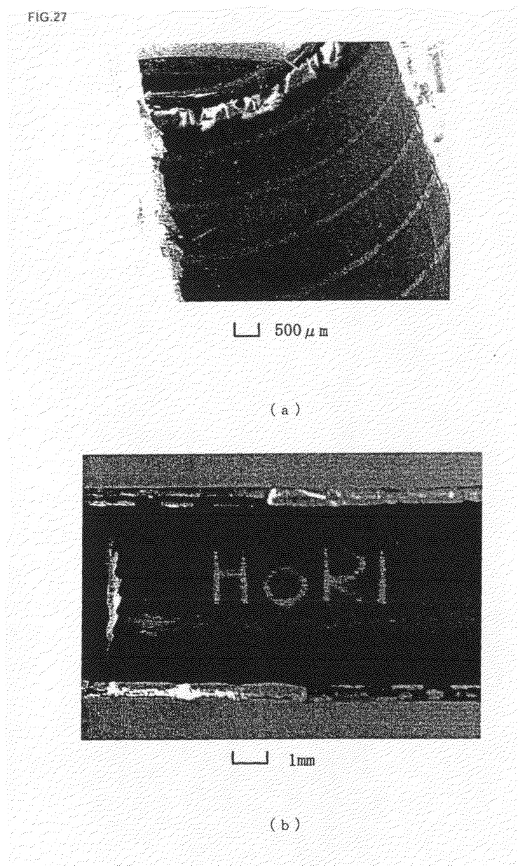

First, the aluminum-made circular tube used as the exposure object was moved in the Y direction and simultaneously rotated about the Y axis to perform exposure, then immersed in the developer for 4 minutes, and rinsed with pure water for 4 minutes, and the pure water was removed by drying. The upper half of the aluminum-made circular tube having the pattern formed thereon was cut and removed, and the inner surface was observed under an electron microscope. FIG. 27 is a set of electron microscope photographs obtained in Example 2 of the present invention, Fig. (a) showing the spiral resist pattern, Fig. (b) showing the character pattern. The whitish portion in the photograph is the resist pattern, and the blackish portion is the resist portion remaining after development. The cut planes of the aluminum-made circular tubes appear on the upper right side and the left side in Fig. (a) and the upper and lower sides in Fig. (b). As can be seen from the scale bars below the photographs, the line width of the resist pattern was about 200 μm.

### EXAMPLE 3

Exposure was performed to form a spiral resist pattern using the inner surface exposure apparatus shown in FIG. 16 with a laser beam used as the exposure light source.

### Exposure Object: Aluminum Alloy-Made Circular Tube

Outer diameter: 1.4 mm, inner diameter: 1 mm, length: 30 mm

### Photosensitive Material on the Inner Surface of the Exposure Object

Resist THMR-iP3300 (product of TOKYO OHKA KOGYO CO., LTD.)

Thickness: about 10 μm

### Exposure Pattern

Spiral resist pattern formed on the inner surface of the tube

### Exposure Light Source: Semiconductor Laser

Wavelength: 406 nm, maximum power: 50 mW, effective power: 35 mW

### Guide Rod: Stainless Steel-Made Circular Rod (Diameter: 0.5 mm)

An end portion was cut at 45 degrees and polished.

### Pinhole: Nickel Made

Hole diameter: about 170 μm, thickness: 20 μm

### Developer: PMER NMD-W

### Relative Speed Between the Exposure Object and the Guide Rod (Exposure Light Beam)

Y direction/Rotation direction (about the Y axis):

Two sets: 4 μm/s/5.8 deg/s and 32 μm/s/11.1 deg/s

First, the aluminum-made circular tube used as the exposure object was moved in the Y direction and simultaneously rotated about the Y axis to perform exposure, then immersed in the developer for 2 minutes, and rinsed with pure water for 1 minute, and the pure water was removed by drying. The upper half of the aluminum-made circular tube having the pattern formed thereon was cut and removed, and the inner surface was observed under an electron microscope.

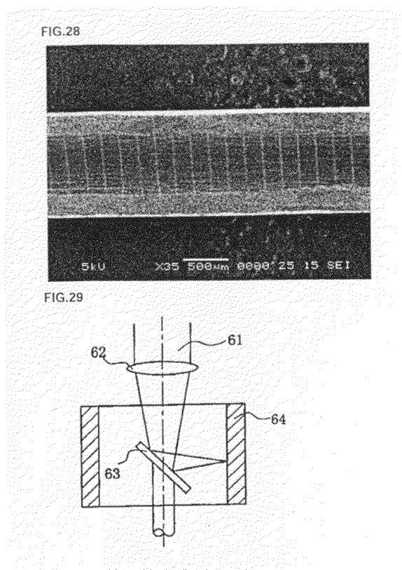

FIG. 28 is an electron microscope photograph of the spiral fine resist pattern obtained in Example 3 of the present invention. The white band-like portions on the upper and lower sides are the tube wall of the aluminum alloy-made circular tube, and the oblique white portions are the spiral resist pattern. The pitch was about 250 μm, and the line width was about 12 μm. In this Example, a spiral resist pattern having a pitch of about 1 mm and a line width of 9 μm was also obtained (not shown).

The fine pattern having a line width much smaller than the line width of “30 to 50 μm” disclosed in Patent Document 2 could be obtained on the very narrow and long circular tubular exposure object having an inner diameter of 1 mm and a length of 30 mm.

### INDUSTRIAL APPLICABILITY

With the present invention, lubrication grooves, air bearing grooves, and the like can be formed in the inner surface of a narrow bearing boss with high efficiency and high accuracy, and conventionally unavailable very small diameter ball screws and ball splines can be obtained.

1. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
light guiding means including a guide rod, the guide rod including an optical fiber for guiding the exposure light beam and at least one reflecting element for guiding to an inner surface of an exposure object the non-reactive light beam that enters the exposure object from an incoming side of the exposure light beam or a side opposite to the incoming side and travels in an axial direction of the exposure object; and
moving means for moving the exposure object and/or the guide rod such that a relative angle between the guide rod and the exposure object and/or relative positions of the guide rod and the exposure object are changed,
wherein, after the irradiation spot of the exposure light beam is brought into focus and/or is adjusted to an exposure starting point while the non-reactive light beam is projected onto a photosensitive material deposited on the inner surface of the exposure object which defines a very small tubular or hole-like void space, the exposure light beam is projected onto a predetermined position on the exposure object to form a predetermined exposed pattern of the photosensitive material deposited on the inner surface of the exposure object.

2. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
light guiding means including a guide rod, the guide rod including a reflecting element for reflecting the exposure light beam in a direction orthogonal to an inner surface of an exposure object and at least another reflecting element for guiding to the inner surface of the exposure object the non-reactive light beam that enters the exposure object from an incoming side of the exposure light beam or a side opposite to the incoming side and travels in an axial direction of the exposure object; and
moving means for moving the exposure object and/or the guide rod such that a relative angle between the guide rod and the exposure object and/or relative positions of the guide rod and the exposure object are changed,
wherein, after the irradiation spot of the exposure light beam is brought into focus and/or is adjusted to an exposure starting point while the non-reactive light beam is projected onto a photosensitive material deposited on the inner surface of the exposure object which defines a very small tubular or hole-like void space, the exposure light beam is projected onto a predetermined position on the exposure object to form a predetermined exposed pattern of the photosensitive material deposited on the inner surface of the exposure object.

3. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
combining means for combining the exposure light beam and the non-reactive light beam;
light guiding means including a guide rod, the guide rod including a reflecting element for reflecting a combined light beam of the exposure light beam and the non-reactive light beam in a direction orthogonal to an inner surface of the exposure object; and
moving means for moving the exposure object and/or the guide rod such that a relative angle between the guide rod and the exposure object and/or relative positions of the guide rod and the exposure object are changed,
wherein, after being combined by the combining means, the exposure light beam and the non-reactive light beam travel inside the guide rod in an axial direction of the guide rod and are reflected in the direction orthogonal to the inner surface of the exposure object by the reflecting element provided in the guide rod, and wherein, after the irradiation spot of the exposure light beam is brought into focus and/or is adjusted to an exposure starting point while the non-reactive light beam is projected onto a photosensitive material deposited on the inner surface of the exposure object which defines a very small tubular or hole-like void space, the exposure light beam is projected onto a predetermined position on the exposure object to form a predetermined exposed pattern of the photosensitive material deposited on the inner surface of the exposure object.

4. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
light guiding means including a guide rod inserted from a side opposite to an incoming side of the exposure light beam into an inner space of an exposure object having a very small tubular or hole-like void space, the guide rod including a reflecting element for reflecting the exposure light beam in a direction orthogonal to an inner surface of the exposure object and at least another reflecting element for guiding to the inner surface of the exposure object the non-reactive light beam that enters the exposure object from the incoming side of the exposure light beam or the side opposite to the incoming side and travels in an axial direction of the exposure object, the at least another reflecting element being provided at one end of the guide rod; and
moving means for moving the exposure object and/or the guide rod such that a relative angle between the guide rod and the exposure object and/or relative positions of the guide rod and the exposure object are changed,
wherein, after the irradiation spot of the exposure light beam is brought into focus and/or is adjusted to an exposure starting point while the non-reactive light beam is projected onto a photosensitive material deposited on the inner surface of the exposure object which defines the very small tubular or hole-like void space, the exposure light beam is projected onto a predetermined position on the exposure object to form a predetermined exposed pattern of the photosensitive material deposited on the inner surface of the exposure object.

5. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
combining means for combining the exposure light beam and the non-reactive light beam;
light guiding means including a guide rod inserted from a side opposite to an incoming side of the exposure light beam into an inner space of an exposure object having a tubular or hole-like void space, the guide rod including a reflecting element for reflecting a combined light beam of the exposure light beam and the non-reactive light beam in a direction orthogonal to an inner surface of the exposure object, the reflecting element being provided at one end of the guide rod; and
moving means for moving the exposure object and/or the guide rod such that a relative angle between the guide rod and the exposure object and/or relative positions of the guide rod and the exposure object are changed,
wherein, after being combined by the combining means, the exposure light beam and the non-reactive light beam travel in the inner space of the exposure object in an axial direction of the exposure object and are reflected in the direction orthogonal to the inner surface of the exposure object by the reflecting element provided at the one end of the guide rod, and wherein, after the irradiation spot of the exposure light beam is brought into focus and/or is adjusted to an exposure starting point while the non-reactive light beam is projected onto a photosensitive material deposited on the inner surface of the exposure object which defines the tubular or hole-like void space having a very small size, the exposure light beam is projected onto a predetermined position on the exposure object to form a predetermined exposed pattern of the photosensitive material deposited on the inner surface of the exposure object.

6. An inner surface exposure apparatus, comprising:
exposure light beam supplying means for supplying an exposure light beam, the means including an exposure light source;
non-reactive light beam supplying means for supplying a non-reactive light beam for detecting an irradiation spot of the exposure light beam, the means including a non-reactive light source;
light guiding means including a guide rod, the guide rod including a light emitting diode serving as the exposure light source and a lead wire for supplying power to the light emitting diode; and
moving means for moving the exposure object and/or the guide rod such that a relative angle between the guide rod and the exposure object and/or relative positions of the guide rod and the exposure object are changed,
wherein, after the irradiation spot of the exposure light beam is brought into focus and/or is adjusted to an exposure starting point while the non-reactive light beam is projected onto a photosensitive material deposited on an inner surface of the exposure object which defines a very small tubular or hole-like void space, the exposure light beam is projected onto a predetermined position on the exposure object to form a predetermined exposed pattern of the photosensitive material deposited on the inner surface of the exposure object.

7. The inner surface exposure apparatus according to claim 1, wherein the exposure object and the guide rod are disposed such that axes thereof are inclined at a predetermined angle.

8. The inner surface exposure apparatus according to claim 1, wherein the optical fiber disposed along the guide rod is bent at one end so as to be perpendicular to the inner surface of the exposure object and wherein the other end of optical fiber is connected to the exposure light source.

9. The inner surface exposure apparatus according to claim 1, wherein: the optical fiber is disposed along the guide rod; and the guide rod further includes a reflecting element, the reflecting element being provided at a predetermined position in front of an emission end of the optical fiber, the reflecting element reflecting the exposure light beam such that the direction of the exposure light beam is changed to a direction orthogonal to the inner surface of the exposure object.

10. The inner surface exposure apparatus according to claim 4, wherein the reflecting element provided at the one end of the guide rod is a reflecting surface formed by mirror-polishing an obliquely cut end of the guide rod.

11. The inner surface exposure apparatus according to claim 1, comprising a pinhole part disposed at a position in an optical path of the exposure light beam that extends from the exposure light source to an exposed surface of the exposure object; and an optical system for forming a point image of an emission outlet of the pinhole part on the exposed surface of the exposure object or the vicinity thereof.

12. The inner surface exposure apparatus according to claim 1, further comprising one of a pinhole part and a lens for reducing the size of the irradiation spot of the exposure light beam to be projected, the one of the pinhole part and the lens being disposed in the inner space of the exposure object and being placed in an end portion of the guide rod so as to come close to an irradiated portion of the inner surface of the exposure object, the irradiated portion being irradiated with the exposure light beam projected onto the exposure object.

13. The inner surface exposure apparatus according to claim 1, further comprising one of a pinhole part and a lens for reducing the size of the irradiation spot of the exposure light beam to be projected, the one of the pinhole part and the lens being disposed at an emission end of the optical fiber that emits the exposure light beam, the emission end being located in an end portion of the guide rod.

14. The inner surface exposure apparatus according to claim 1 wherein the exposure light beam is a laser beam.

15. The inner surface exposure apparatus according to claim 1, wherein the non-reactive light beam has a wavelength range different from that of the exposure light beam.

16. (canceled)
